(19) United States
(12) Patent Application Publication
(10) Pub. No.: US 2022/0362853 A1
(43) Pub. Date: Nov. 17, 2022

(54) Grayscale Area Printing for Additive Manufacturing

(71) Applicant: Seurat Technologies, Inc., Wilmington, MA (US)

(72) Inventors: Nicholas C. Ferreri, Portsmouth, NH (US); April L. Cooke, Billerica, MA (US); Ning Duanmu, Nashua, MA (US); Yiyu Shen, Trwksbury, MA (US); Brandon J. Mello, Kensington, NH (US); Francis L. Leard, Sudbury, MA (US); Andrew J. Bayramian, Marblehead, MA (US); Kourosh Kamshad, Hudson, NH (US); James A. DeMuth, Woburn, MA (US)

(21) Appl. No.: 17/827,393

(22) Filed: May 27, 2022

Related U.S. Application Data
(63) Continuation-in-part of application No. 17/091,915, filed on Nov. 6, 2020.
Application No. 17/091,915 is a continuation-in-part of application No. 15/337,507, filed on Oct. 28, 2016, now Pat. No. 10,960,466.
Application No. 15/337,507 is a continuation-in-part of application No. 15/977,476, filed on May 11, 2018.
Application No. 15/977,476 is a continuation-in-part of application No. 17/506,349, filed on Oct. 20, 2021.
Application No. 17/506,349 is a continuation-in-part of application No. 17/513,005, filed on Oct. 28, 2021.
Application No. 17/513,005 is a continuation-in-part of application No. 17/513,402, filed on Oct. 28, 2021.
Application No. 17/513,402 is a continuation-in-part of application No. 17/513,230, filed on Oct. 28, 2021.
Application No. 17/513,230 is a continuation-in-part of application No. 17/670,149, filed on Feb. 11, 2022.
(60) Provisional application No. 62/248,758, filed on Oct. 30, 2015.
(60) Provisional application No. 62/248,765, filed on Oct. 30, 2015.
(60) Provisional application No. 62/248,770, filed on Oct. 30, 2015.
(60) Provisional application No. 62/248,776, filed on Oct. 30, 2015.
(60) Provisional application No. 62/248,783, filed on Oct. 30, 2015.
(60) Provisional application No. 62/248,791, filed on Oct. 30, 2015.
(60) Provisional application No. 62/248,799, filed on Oct. 30, 2015.
(60) Provisional application No. 62/248,966, filed on Oct. 30, 2015.
(60) Provisional application No. 62/248,968, filed on Oct. 30, 2015.
(60) Provisional application No. 62/248,969, filed on Oct. 30, 2015.
(60) Provisional application No. 62/248,980, filed on Oct. 30, 2015.
(60) Provisional application No. 62/248,989, filed on Oct. 30, 2015.
(60) Provisional application No. 62/248,780, filed on Oct. 30, 2015.
(60) Provisional application No. 62/248,787, filed on Oct. 30, 2015.
(60) Provisional application No. 62/248,795, filed on Oct. 30, 2015.
(60) Provisional application No. 62/248,821, filed on Oct. 30, 2015.
(60) Provisional application No. 62/248,829, filed on Oct. 30, 2015.
(60) Provisional application No. 62/248,833, filed on Oct. 30, 2015.
(60) Provisional application No. 62/248,835, filed on Oct. 30, 2015.
(60) Provisional application No. 62/248,839, filed on Oct. 30, 2015.
(60) Provisional application No. 62/248,841, filed on Oct. 30, 2015.
(60) Provisional application No. 62/248,847, filed on Oct. 30, 2015.
(60) Provisional application No. 62/248,848, filed on Oct. 30, 2015.
(60) Provisional application No. 62/504,853, filed on May 11, 2017.
(60) Provisional application No. 63/105,066, filed on Oct. 23, 2020.
(60) Provisional application No. 63/107,077, filed on Oct. 29, 2020.
(60) Provisional application No. 63/107,303, filed on Oct. 29, 2020.
(60) Provisional application No. 63/107,310, filed on Oct. 29, 2020.
(60) Provisional application No. 63/148,788, filed on Feb. 12, 2021.

(51) Int. Cl. B22F 10/36; B22F 10/28; B22F 12/43; B22F 12/42; B22F 12/45; B33Y 10/00; B33Y 30/00

(52) U.S. Cl. CPC B22F 10/36; B22F 10/28; B22F 12/43; B22F 12/42; B22F 12/45; B33Y 10/00; B33Y 30/00

(57) ABSTRACT

An additive manufacturing system includes one or more light sources and one or more light valves that can be written with two-dimensional gray scale patterns that the light valves impose on beams from the one or more light sources to obtain one or more patterned beams. The one or more patterned beams are steered to each area of a plurality of areas on a layer of powder. The two-dimensional gray scale patterns are selected to achieve desired material properties at each pixel position of the patterned beam incident on the layer of powder. The light valves may modulate one or more of amplitude, phase, or coherence. The material properties may include one or more of Young's modulus, porosity, grain size, and crystalline microstructure.

### CROSS-REFERENCE TO RELATED PATENT APPLICATION

This application is a continuation-in-part of U.S. patent application Ser. No. 17/091,915, filed on Nov. 6, 2020, which is a continuation-in-part of U.S. patent application Ser. No. 15/337,507, filed on Oct. 28, 2016, which claims the benefit of the following provisional applications:

U.S. Patent Application No. 62/248,758, filed on Oct. 30, 2015,

U.S. Patent Application No. 62/248,765, filed on Oct. 30, 2015,

U.S. Patent Application No. 62/248,770, filed on Oct. 30, 2015,

U.S. Patent Application No. 62/248,776, filed on Oct. 30, 2015,

U.S. Patent Application No. 62/248,783, filed on Oct. 30, 2015,

U.S. Patent Application No. 62/248,791, filed on Oct. 30, 2015,

U.S. Patent Application No. 62/248,799, filed on Oct. 30, 2015,

U.S. Patent Application No. 62/248,966, filed on Oct. 30, 2015,

U.S. Patent Application No. 62/248,968, filed on Oct. 30, 2015,

U.S. Patent Application No. 62/248,969, filed on Oct. 30, 2015,

U.S. Patent Application No. 62/248,980, filed on Oct. 30, 2015,

U.S. Patent Application No. 62/248,989, filed on Oct. 30, 2015,

U.S. Patent Application No. 62/248,780, filed on Oct. 30, 2015,

U.S. Patent Application No. 62/248,787, filed on Oct. 30, 2015,

U.S. Patent Application No. 62/248,795, filed on Oct. 30, 2015,

U.S. Patent Application No. 62/248,821, filed on Oct. 30, 2015,

U.S. Patent Application No. 62/248,829, filed on Oct. 30, 2015,

U.S. Patent Application No. 62/248,833, filed on Oct. 30, 2015,

U.S. Patent Application No. 62/248,835, filed on Oct. 30, 2015,

U.S. Patent Application No. 62/248,839, filed on Oct. 30, 2015,

U.S. Patent Application No. 62/248,841, filed on Oct. 30, 2015,

U.S. Patent Application No. 62/248,847, filed on Oct. 30, 2015, and

U.S. Patent Application No. 62/248,848, filed on Oct. 30, 2015.

This application is a continuation-in-part of U.S. patent application Ser. No. 15/977,476, filed on May 11, 2018, which claims the benefit of U.S. Provisional Patent Application No. 62/504,853, filed on May 11, 2017.

This application is a continuation-in-part of U.S. patent application Ser. No. 17/506,349, filed on Oct. 20, 2021, which claims the benefit of U.S. Provisional Patent Application No. 63/105,066, filed on Oct. 23, 2020.

This application is a continuation-in-part of U.S. patent application Ser. No. 17/513,005, filed on Oct. 28, 2021, which claims the benefit of U.S. Provisional Patent Application No. 63/107,077, filed on Oct. 29, 2020.

This application is a continuation-in-part of U.S. patent application Ser. No. 17/513,402, filed on Oct. 28, 2021, which claims the benefit of U.S. Provisional Patent Application No. 63/107,303, filed on Oct. 29, 2020.

This application is a continuation-in-part of U.S. patent application Ser. No. 17/513,230, filed on Oct. 28, 2021, which claims the benefit of U.S. Provisional Patent Application No. 63/107,310, filed on Oct. 29, 2020.

This application is a continuation-in-part of U.S. patent application Ser. No. 17/670,149, filed on Feb. 11, 2022, which claims the benefit of U.S. Provisional Patent Application No. 63/148,788, filed on Feb. 12, 2021. All of the foregoing are hereby incorporated by reference.

### TECHNICAL FIELD

The present disclosure generally relates to optics for additive manufacturing and, more specifically, to additive manufacturing including fusing powder with a laser.

### BACKGROUND

Current Energy Deposited Printed Bed Fusion Additive Manufacturing (ED-PBF-AM) uses a single point of energy to melt powder (metal, ceramic, glass, or glassy-like materials) to form/print a 3D part. This enables the rapid manufacture of parts and the manufacture of parts that cannot be made with conventional machining techniques. Parts made using this technique may be used for prototyping and may have sufficient strength and precision for production parts.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates an additive manufacturing system;

FIG. 1B is a top view of a structure being formed on an additive manufacturing system;

FIG. 2 illustrates an additive manufacturing method;

FIG. 3A is a cartoon illustrating an additive manufacturing system including lasers;

FIG. 3B is a detailed description of the light patterning unit shown in FIG. 3A;

FIG. 3C is one embodiment of an additive manufacturing system with a “switchyard” for directing and repatterning light using multiple image relays;

FIG. 3D illustrates a switchyard system supporting reuse of patterned two-dimensional energy;

FIG. 3E illustrates a mirror image pixel remapping;

FIG. 3F illustrates a series of image transforming image relays for pixel remapping;

FIG. 4A is a diagram of a layout of an energy patterning binary tree system for laser light recycling in an additive manufacturing process in accordance with an embodiment of the present disclosure;

FIG. 4B is a diagram of illustrating pattern recycling from one input to multiple outputs;

FIG. 4C is a diagram of illustrating pattern recycling from multiple inputs to one output;

FIG. 4D is a schematic example of an implementation of the switchyard concept supporting two light valve patterning steps and beam re-direction where switching is available for at least some energy steering units;

FIG. 4E is a schematic example of an implementation of the switchyard concept supporting two light valve patterning steps and beam re-direction where switching is available for all energy steering units;

FIG. 5A is a cartoon illustrating area printing of multiple tiles using a solid-state system with a print bar;

FIG. 5B is a cartoon illustrating area printing of multiple tiles using a solid-state system with a matrix sized to be coextensive with a powder bed;

FIG. 5C is a cartoon illustrating area printing of multiple tiles using a solid-state system with a matrix having individual steering units and sized to be coextensive with a powder bed;

FIG. 6A is a diagram illustrating the control of Young's modulus control of a printed part using two-dimensional gray scale patterns;

FIG. 6B is a diagram illustrating the control of macroscopically aligned crystallography using two-dimensional gray scale patterns;

FIG. 6C illustrating temporal structuring of printing using two-dimensional gray scale patterns to control material characteristics;

FIG. 6D illustrates examples of temporal structuring of grayscale printing in the control of material characteristics;

FIG. 7 is a schematic illustration of a part being manufactured with supports in accordance with an embodiment of the present invention;

FIG. 8 is a schematic diagram illustrating printed and non-printed pixels;

FIG. 9 is a schematic diagram illustrating a volume of pixels.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The present disclosure proposes an optical system suitable for reducing the light wasted in the additive manufacturing system as caused by rejection of unwanted light due to the pattern to be printed. The proposed optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light and used to maintain high throughput rates. Moreover, the thrown-away energy may be recycled and reused to increase intensity to print more difficult materials.

By recycling and re-using rejected light, system intensity can be increased proportional to the fraction of light rejected. This allows for all the energy to be used to maintain high printing rates. Additionally, the recycling of the light potentially enables a “bar” print where a single bar sweeps across the build platform. Alternatively, pattern recycling could allow creation of a solid-state matrix coextensive with the build platform that does not require movement to print all areas of the build platform.

An additive manufacturing system is disclosed which has one or more energy sources, including in one embodiment, one or more laser or electron beams, positioned to emit one or more energy beams. Beam shaping optics may receive the one or more energy beams from the energy source and form a single beam. An energy patterning unit receives or generates the single beam and transfers a two-dimensional pattern to the beam, and may reject the unused energy not in the pattern. An image relay receives the two-dimensional patterned beam and focuses it as a two-dimensional image to a desired location on a height fixed or movable build platform (e.g. a powder bed). In certain embodiments, some or all of any rejected energy from the energy patterning unit is reused.

In various examples, multiple beams from the laser array(s) are combined using a beam homogenizer. This combined beam can be directed at an energy patterning unit that includes either a transmissive or reflective pixel addressable light valve. In one embodiment, the pixel addressable light valve includes both a liquid crystal module having a polarizing element and a light projection unit providing a two-dimensional input pattern. The two-dimensional image focused by the image relay can be sequentially directed toward multiple locations on a powder bed to build a 3D structure.

The additive manufacturing system may make use of gray scale patterns in order control material properties corresponding to each pixel position of the patterns. The material properties may include Young's modulus, porosity, grain size, and microcrystalline structure. The gray scale patterns may be imposed on beams by light valves modulating one or more of amplitude, phase, and coherence.

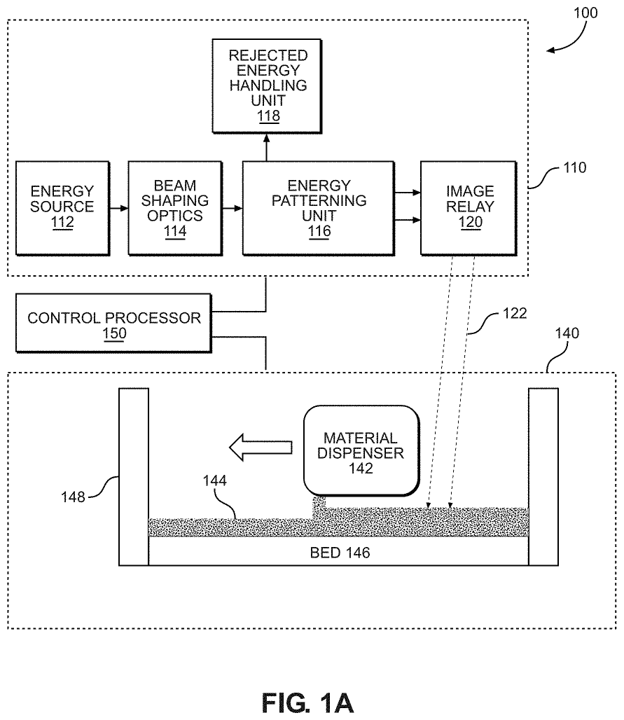

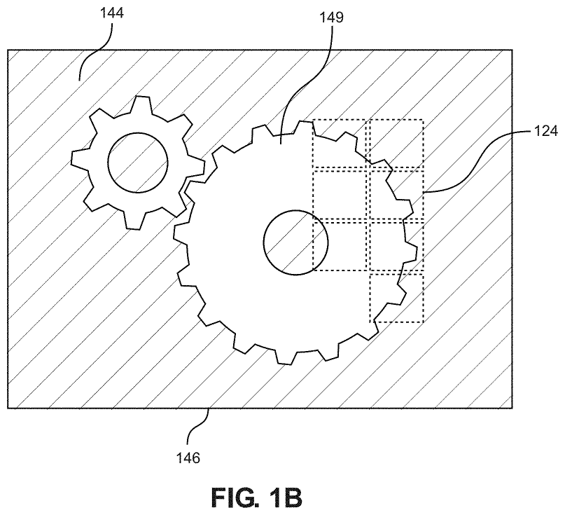

As seen in FIG. 1, an additive manufacturing system 100 has an energy patterning system 110 with an energy source 112 that can direct one or more continuous or intermittent energy beam(s) toward beam shaping optics 114. After shaping, if necessary, the beam is patterned by an energy patterning unit 116, with generally some energy being directed to a rejected energy handling unit 118. Patterned energy is relayed by image relay 120 toward an article processing unit 140, typically as a two-dimensional image 122 focused near a bed 146. The bed 146 (with optional walls 148) can form a chamber containing material 144 dispensed by material dispenser 142. Patterned energy, directed by the image relay 120, can melt, fuse, sinter, amalgamate, change crystal structure, influence stress patterns, or otherwise chemically or physically modify the dispensed material 144 to form structures with desired properties.

Energy source 112 generates photon (light), electron, ion, or other suitable energy beams or fluxes capable of being directed, shaped, and patterned. Multiple energy sources can be used in combination. The energy source 112 can include lasers, incandescent light, concentrated solar, other light sources, electron beams, or ion beams. Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser.

A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO4) laser, Neodymium doped yttrium calcium oxoborateNd:YCa₄O(BO₃)³ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm⁺³:Glass) solid-state laser, Chromium doped chrysoberyl (alexandrite) laser, Erbium doped anderbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

For example, in one embodiment a single Nd:YAG q-switched laser can be used in conjunction with multiple semiconductor lasers. In another embodiment, an electron beam can be used in conjunction with an ultraviolet semiconductor laser array. In still other embodiments, a two-dimensional array of lasers can be used. Pre-patterning of an energy beam can be done by selectively activating and deactivating energy sources.

Beam shaping unit 114 can include a great variety of imaging optics to combine, focus, diverge, reflect, refract, homogenize, adjust intensity, adjust frequency, or otherwise shape and direct one or more energy beams received from the energy source 112 toward the energy patterning unit 116. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Energy patterning unit 116 can include static or dynamic energy patterning elements. For example, photon, electron, or ion beams can be blocked by masks with fixed or movable elements. To increase flexibility and ease of image patterning, pixel addressable masking, image generation, or transmission can be used. In some embodiments, the energy patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In yet another embodiment, an electron patterning device receives an address pattern from an electrical or photon stimulation source and generates a patterned emission of electrons.

Rejected energy handling unit 118 is used to disperse, redirect, or utilize energy not patterned and passed through the energy pattern image relay 120. In one embodiment, the rejected energy handling unit 118 can include passive or active cooling elements that remove heat from the energy patterning unit 116. In other embodiments, the rejected energy handling unit can include a “beam dump” to absorb and convert to heat any beam energy not used in defining the energy pattern. In still other embodiments, rejected beam energy can be recycled using beam shaping optics 114. Alternatively, or in addition, rejected beam energy can be directed to the article processing unit 140 for heating or further patterning. In certain embodiments, rejected beam energy can be directed to additional energy patterning systems or article processing units. Any of the above techniques may be used in combination in rejected energy handling unit 118 to disperse, redirect, or utilize energy not patterned and passed through the energy pattern image relay 120.

Image relay 120 receives a patterned image (typically two-dimensional) from the energy patterning unit 116 and guides it toward the article processing unit 140. In a manner similar to beam shaping optics 114, the image relay 120 can include optics to combine, focus, diverge, reflect, refract, adjust intensity, adjust frequency, or otherwise shape and direct the patterned image.

Article processing unit 140 can include a walled chamber 148 and bed 144, and a material dispenser 142 for distributing material. The material dispenser 142 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. For example, slurries, sprays, coatings, wires, strips, or sheets of materials can be used. Unwanted material can be removed for disposable or recycling by use of blowers, vacuum systems, sweeping, vibrating, shaking, tipping, or inversion of the bed 146.

In addition to material handling components, the article processing unit 140 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals).

Control processor 150 can be connected to control any components of additive manufacturing system 100. The control processor 150 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 150 is provided with an interface to allow input of manufacturing instructions. Use of a wide range of sensors allows various feedback control mechanisms that improve quality, manufacturing throughput, and energy efficiency.

FIG. 1B is a cartoon illustrating a bed 146 that supports material 144. Using a series of sequentially applied, two-dimensional patterned energy beam images (squares in dotted outline 124), a structure 149 is additively manufactured. As will be understood, image patterns having non-square boundaries can be used, overlapping or interpenetrating images can be used, and images can be provided by two or more energy patterning systems. In other embodiments, images can be formed in conjunction with directed electron or ion beams, or with printed or selective spray systems.

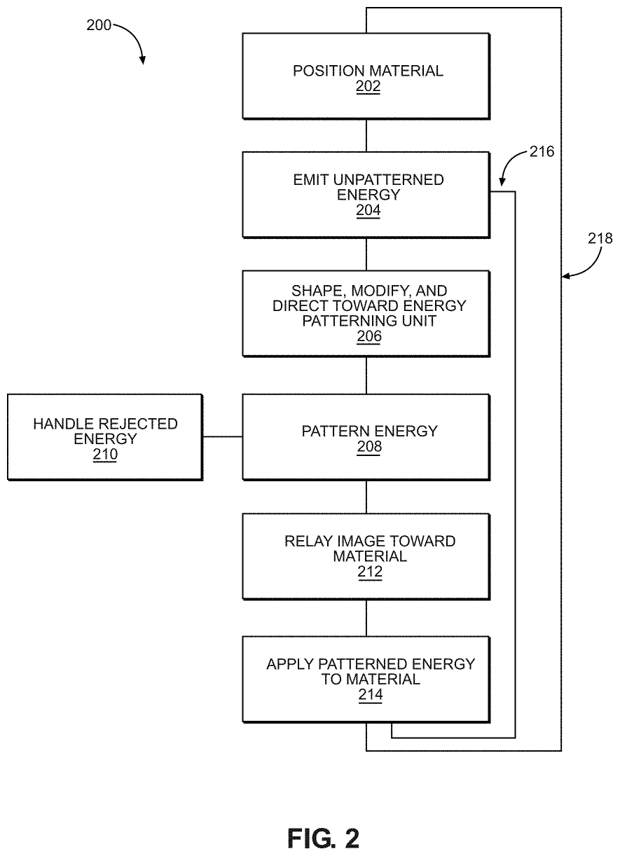

FIG. 2 is a flow chart illustrating one embodiment of an additive manufacturing process supported by the described optical and mechanical components. In step 202, material is positioned in a bed, chamber, or other suitable support. The material can be a powder capable of being melted, fused, sintered, induced to change crystal structure, have stress patterns influenced, or otherwise chemically or physically modified to form structures with desired properties.

In step 204, unpatterned energy is emitted by one or more energy emitters, including but not limited to solid state or semiconductor lasers, or electrical power supply flowing electrons down a wire. In step 206, the unpatterned energy is shaped and modified (e.g. intensity modulated or focused). In step 208, this unpatterned energy is patterned, with energy not forming a part of the pattern being handled in step 210 (this can include conversion to waste heat, or recycling as patterned or unpatterned energy). In step 212, the patterned energy, now forming a two-dimensional image is relayed toward the material. In step 214, the image is applied to the material, building a portion of a 3D structure. These steps can be repeated (loop 218) until the image (or different and subsequent image) has been applied to all necessary regions of a top layer of the material. When application of energy to the top layer of the material is finished, a new layer can be applied (loop 216) to continue building the 3D structure. These process loops are continued until the 3D structure is complete, when remaining excess material can be removed or recycled.

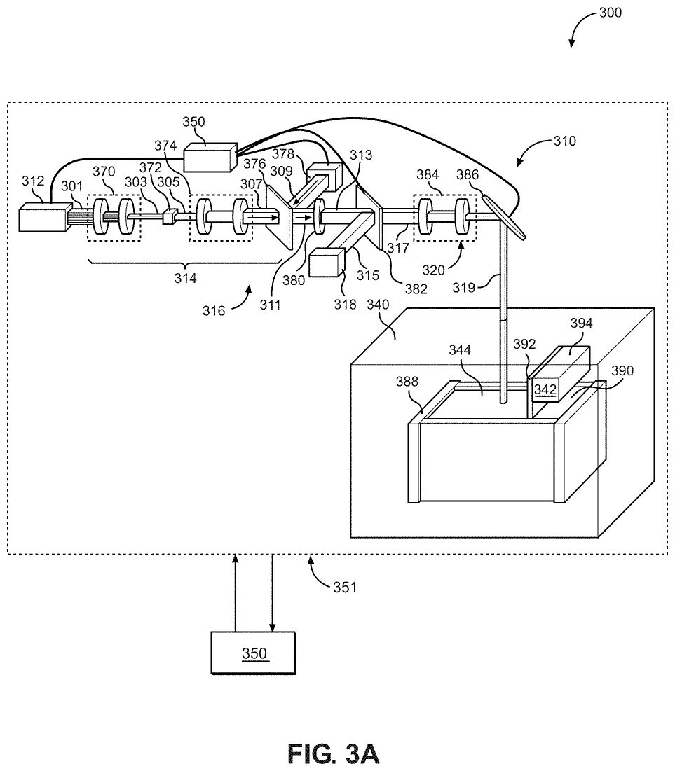

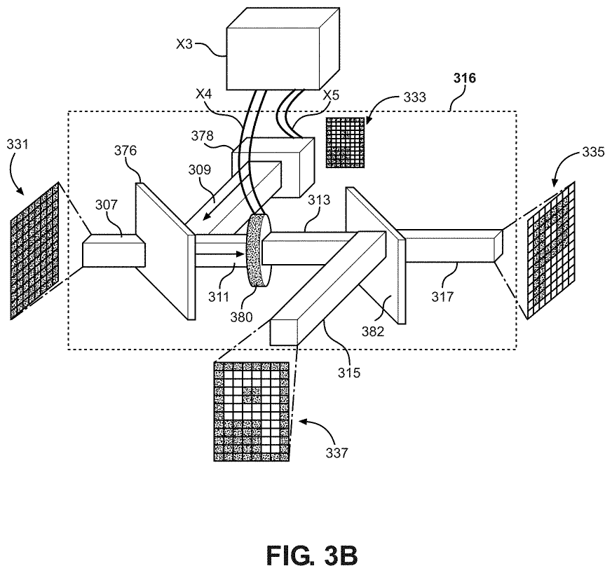

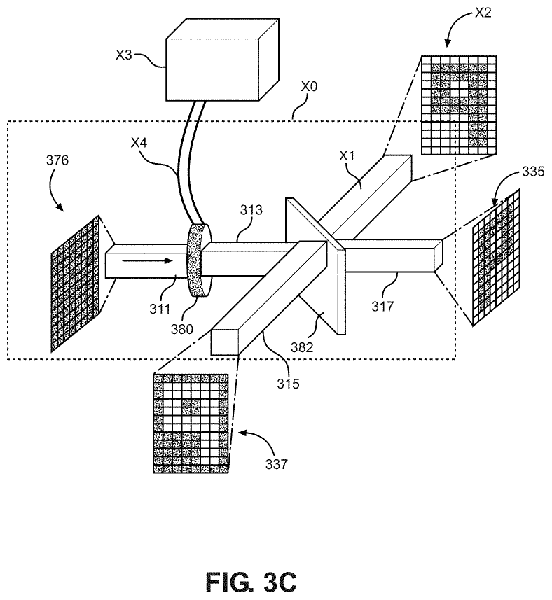

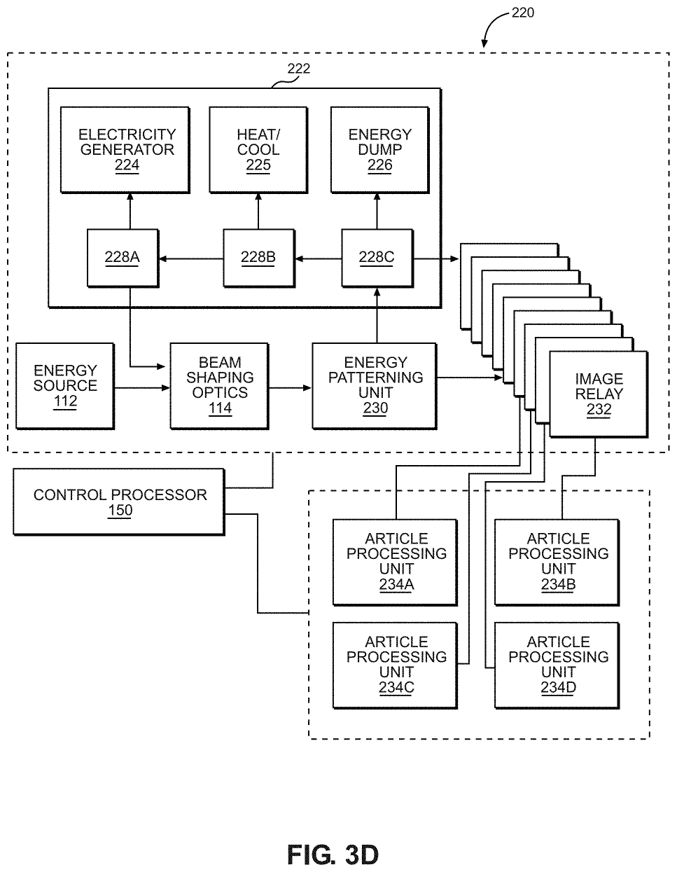

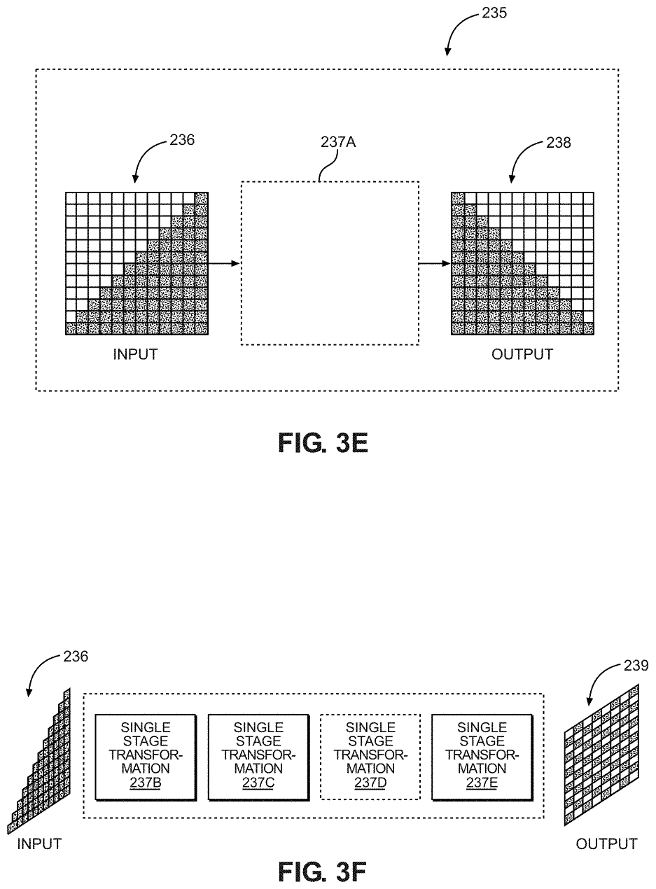

FIG. 3A is one embodiment of an additive manufacturing system 300 that uses multiple semiconductor lasers as part of an energy patterning system 310. A control processor 350 can be connected to variety of sensors, actuators, heating or cooling systems, monitors, and controllers to coordinate operation of multiple lasers 312, light patterning unit 316, and image relay 320, as well as any other component of system 300. These connections are generally indicated by a dotted outline 351 surrounding components of system 300. As will be appreciated, connections can be wired or wireless, continuous or intermittent, and include capability for feedback (for example, thermal heating can be adjusted in response to sensed temperature). The multiple lasers 312 can emit a beam 301 of light at, for example a 1000 nm wavelength that 90 mm wide by 20 mm tall. The beam 301 is resized by imaging optics 370 to create beam 303. In one example beam 303 is 6 mm wide by 6 mm tall, Beam 3 is incident on light homogenization device 372 which blends light together to create blended beam 305. Beam 305 is then incident on imaging assembly 374 which reshapes the light into beam 307 and is then incident on hot cold mirror 376. The mirror 376 can allow a first wavelength of light to pass but reflects a second wavelength, for example the mirror can allow 1000 nm light to pass, but reflect 450 nm light. A light projector 378 capable of projecting low power light at, for example, 1080p pixel resolution and 450 nm emits beam 309, which is then incident on hot cold mirror 376. The beam 309 may be a two-dimensional pattern (e.g., image) in which each pixel of the pattern is independently controllable. The intensity of each pixel may be independently set to a range of possible values such that the two-dimensional pattern is a gray scale pattern. As used herein “gray scale” shall be understood to mean at least three levels including zero intensity, a maximum intensity, and one or more intensities between the zero and maximum. For example, the number of levels may be at least 8, at least 16, at least 32, at least 64, at least 128, or any value of greater than or equal to 2\hat{ }N, where N is greater than 1. A gray scale pattern or image as used herein need not include each level of a number of levels but rather include at least three levels that are not equal to each other and each level may be selected from the range of available levels. Beams 307 and 309 overlay in beam 311, and both are imaged onto optically addressed light valve 380, for example in a 20 mm wide, 20 mm tall image. Images formed from the homogenizer 372 and the projector 378 are recreated and overlaid on light valve 380.

The optically addressed light valve 380 is stimulated by the light (In an example the wavelength of the light can be in the range from 400-500 nm) and imprints a polarization rotation pattern in transmitted beam 313 which is incident upon polarizer 382. The polarizer 382 splits the two polarization states, transmitting p-polarization into beam 317 and reflecting s-polarization into beam 315 which is then sent to a beam dump 318 that handles the rejected energy. As will be understood, in other embodiments the polarization could be reversed, with s-polarization formed into beam 317 and reflecting p-polarization into beam 315. Beam 317 enters the final imaging assembly 320 which includes optics 384 that resize the patterned light. This beam reflects off of a movable mirror 386 to beam 319, which terminates in a focused image applied to material bed 344 in an article processing unit 340. The depth of field in the image selected to span multiple layers, providing optimum focus in the range of a few layers of error or offset.

The optically addressed light valve 380 may be embodied as various optical devices that affect other properties of the beam 307 output by the laser 312 responsive to the patterned beam 309, which may be a gray scale patterned beam. The frequencies used for the patterned beam 309 correspond to the frequencies required to impose a pattern onto the various optical devices used in the examples below.

In a first alternative example, the polarizer 382 is omitted and the light valve 380 is embodied as the light valve described in Ser. No. 17/506,349. In such embodiments, the light valve 380 may include a photoconductor layer and electro-optical layer between transparent conductive oxide layers. The patterned beam 309 illuminates the photoconductive layer as a scanned beam creating a two-dimensional gray scale pattern or a two-dimensional image defining the two-dimensional gray scale pattern. In either case, the intensity and/or wavelength at each position in the two-dimensional pattern is independently controllable to impose the two-dimensional gray scale pattern onto the photoconductive layer. The two-dimensional gray scale pattern imposed on the photoconductive layer causes a corresponding two-dimensional gray scale pattern to be imposed on the beam 307 incident on the light valve 380 resulting in the output beam 313 exiting the light valve 380 having the corresponding gray scale pattern. The output beam 313 may then be input to the final imaging optics 320 without first passing through the polarizer 382.

In a second alternative example, the light valve 380 imposes a patterned phase change on the beam 307 and the polarizer 382 is embodied as a pattern separator having a phase-dependent transmittivity as disclosed in Ser. No. 17/513,005. The light valve 380 may include a phase change material (e.g., crystalline, amorphous, liquid crystal, glass, ceramic, polymer, quantum dot, artificial dielectric, plasmonic, or metamaterial). In other examples, a pixel strained phase change light valve is used. The phase change light valve is written by a two-dimensionally patterned write beam, which may be a gray-scale pattern. Upon passing through the phase change light valve, the beam 307 experiences a two-dimensional pattern of localized phase changes to obtain the beam 313 with a two-dimensional phase pattern imposed thereon. The beam 313 is then passed through a pattern separator with phase-dependent transmittivity, resulting in the beam 317 having a two-dimensional amplitude pattern corresponding to the two-dimensional gray scale pattern.

In a third alternative example, the polarizer 382 is omitted and the light valve 380 is a quantum dot resonance-based light valve (QDRLV) or quantum dot resonance-controlled diffractive light valve as described in Ser. No. 17/513,402. that are illuminated by the patterned beam 309, which includes a two-dimensional gray scale pattern. The beam 307 is incident on the light valve 380 and the beam 313 exiting the light valve 380 has a two-dimensional amplitude pattern corresponding to the two-dimensional gray scale pattern. The beam 313 may then be incident on the final imaging optics 320.

In a fourth alternative example, the polarizer 382 is omitted and the light valve 380 is holographic light valve as disclosed in Ser. No. 17/670,149. The holographic light valve 380 may include a photoconductive layer illuminated by a two-dimensional gray scale write pattern in the beam 309. The beam 309 has a first frequency and causes the photoconductive layer to impose a corresponding two-dimensionally patterned field to be imposed on a plurality of transparent conductive oxide (TCO) layers. Upon passing through the TCO layers, the TCO layers impose a corresponding two-dimensional phased pattern on the beam 307. A lambda magic mirror (LMM) is illuminated by a second two-dimensional gray scale write pattern at a second frequency different from the first frequency. The LMM imposes a gray scale amplitude pattern onto the phase-patterned beam output by the TCO layers such that the beam 313 output from the light valve 380 is a phase and amplitude patterned high fluence beam. The beam 313 may then be incident on the final imaging optics 320.

In a fifth alternative example, the light valve is an LMM as described in Ser. No. 17/513,402. The LMM is illuminated by a two-dimensional gray scale write pattern from the projector 378 such that when the beam 307 is incident thereon, coherency is locally changed across the LMM such that a portion of the beam 307 is steered according to the coherency change, resulting in the beam 313 having a two-dimensional amplitude pattern corresponding to the two-dimensional gray scale write pattern.

In a sixth example, the light valve 380 is replaced with a high-speed electron beam addressed reflective light valve (EBA-RLV) described in Ser. No. 17/091,915, 17/513,230. The beam 307 is incident on the EBA-RLV. The projector 378 and polarizer 382 may be emitted and replaced with an electron beam scanner. The electron beam is scanned across the EBA-RLV to impose a two-dimensional gray scale pattern thereon. The voltage of the electron beam may be modulated as it is scanned over the EBA-RLV to impose the two-dimensional gray scale pattern onto the EBA-RLV. The beam 307 is incident on the EBA-RLV and a reflected portion, which has a two-dimensional amplitude pattern corresponding to the two-dimensional gray scale pattern, is used as the beam 313. The beam 313 may then be incident on the final imaging optics 320.

The bed 390 can be raised or lowered (vertically indexed) within chamber walls 388 that contain material 344 dispensed by material dispenser 342. In certain embodiments, the bed 390 can remain fixed, and optics of the final imaging assembly 320 can be vertically raised or lowered. Material distribution is provided by a sweeper mechanism 392 that can evenly spread powder held in hopper 394, being able to provide new layers of material as needed. An image, for example 6 mm wide by 6 mm tall, can be sequentially directed by the movable mirror 386 at different positions of the bed.

When using a powdered ceramic or metal material in this additive manufacturing system 300, the powder can be spread in a thin layer, approximately 1-3 particles thick, on top of a base substrate (and subsequent layers) as the part is built. When the powder is melted, sintered, or fused by a patterned beam 319, it bonds to the underlying layer, creating a solid structure. The patterned beam 319 can be operated in a pulsed fashion, for example at a frequency of 40 Hz, moving to the subsequent, for example 6 mm×6 mm, image locations at intervals in a range of 10 ms to 0.5 ms (in various examples the interval range is 3 ms to 0.1 ms) until the selected patterned areas of powder have been melted. The bed 390 then lowers itself by a thickness corresponding to one layer, and the sweeper mechanism 392 spreads a new layer of powdered material. This process is repeated until the 2D layers have built up the desired 3D structure. In certain embodiments, the article processing unit 340 can have a controlled atmosphere. This allows reactive materials to be manufactured in an inert gas, or vacuum environment without the risk of oxidation or chemical reaction, or fire or explosion (if reactive metals are used).

FIG. 3B illustrates in more detail operation of the light patterning unit 316 of FIG. 3A. As seen in FIG. 3B, a representative input pattern 333 (here seen as the numeral “9”) is defined in an 8×12 pixel array of light projected as beam 309 toward mirror 376. Each grey pixel represents a light filled pixel, while white pixels are unlit. In practice, each pixel can have varying levels of light, including light-free, partial light intensity, or maximal light intensity. Unpatterned light 331 that forms beam 307 is directed and passes through a hot/cold mirror 376, where it combines with patterned beam 309. Patterned beam 309 is generated by light projector 378 which is controlled by computer X3 by cabling X5. After reflection by the hot/cold mirror 376, the patterned light beam 311 formed from overlay of beams 307 and 309 in beam 311, and both are imaged onto optically addressed light valve 380. The optically addressed light valve 380, which would rotate the polarization state of unpatterned light 331, is stimulated by the patterned light beam 309/311, and electrical signal coming from computer X3 by cabling X4, to selectively not rotate the polarization state of polarized light 307/311 in the pattern of the numeral “9” into beam 313. The unrotated light representative of pattern 333 in beam 313 is then allowed to pass through polarizer mirror 382 resulting in beam 317 and pattern 335. Polarized light in a second rotated state is rejected by polarizer mirror 382, into beam 315 carrying the negative pixel pattern 337 consisting of a light-free numeral “9”.

Other types of light valves can be substituted or used in combination with the described light valve. Reflective light valves, or light valves base on selective diffraction or refraction can also be used. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning. For electron beam patterning, these valves may selectively emit electrons based on an address location, thus imbuing a pattern on the beam of electrons leaving the valve.

FIG. 3C illustrates the detail and operation of an energy switching unit X0. As seen in FIG. 3C, a beam of light 311, carrying a representative input pattern 376 (here seen as the numeral “9” in an 8×12 pixel array) in the s-polarization state is incident on a single pixel liquid crystal (LC) cell 380. The LC cell 380 which, if desired, would rotate the polarization state of beam 311, is electrically stimulated computer X3 though cabling X4, to selectively rotate the polarization state of polarized light 311 into p-polarization state in beam 313 which would then pass the entire beam through polarizer element 382 into beam 317 carrying image information 335. Alternatively the LC cell 380 could be directed by computer X3 through cabling X4 to not rotate the polarization state of beam 311, preserving the polarization state of s-polarization in beam 313, causing a reflection into beam 315 carrying image information 337. The polarizer element 382 can also be used to receive light from source beam X1 carrying image information X2. The routing of beam X1 is entirely passive based on its polarization state, if X1 is s-pol it will reflect into beam 317, or alternatively if it is p-pol it will transmit into beam 315 (or vice-versa).

Other types of energy switching devices can be substituted or used in combination with the described LC cell. Reflective LC cells, or energy switching devices base on mechanical movements such as a move-able mirror, or selective refraction can also be used, piezo or micro-actuated optical systems, fixed or movable masks, or shields, or any other conventional system able to provide high intensity energy switching. For electron beams these switching mechanisms may consist of large EM field arrays directing the beam to different channels or routes.

FIG. 3D is one embodiment of an additive manufacturing system that includes a switchyard system enabling reuse of patterned two-dimensional energy. Similar to the embodiment discussed with respect to FIG. 1A, an additive manufacturing system 220 has an energy patterning system with an energy source 112 that directs one or more continuous or intermittent energy beam(s) toward beam shaping optics 114. After shaping, the beam is two-dimensionally patterned by an energy patterning unit 230, with generally some energy being directed to a rejected energy handling unit 222. Patterned energy is relayed by one of multiple image relays 232 toward one or more article processing units 234A, 234B, 234C, or 234D, typically as a two-dimensional image focused near a movable or fixed height bed. The bed (with optional walls) can form a chamber containing material dispensed by material dispenser. Patterned energy, directed by the image relays 232, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Relays 228A, 228B, and 228C can respectively transfer energy to an electricity generator 224, a heat/cool thermal management system 225, or an energy dump 226. Optionally, relay 228C can direct patterned energy into the image relay 232 for further processing. In other embodiments, patterned energy can be directed by relay 228C, to relay 228B and 228A for insertion into the energy beam(s) provided by energy source 112. Reuse of patterned images is also possible using image relay 232. Images can be redirected, inverted, mirrored, sub-patterned, or otherwise transformed for distribution to one or more article processing units. 234A-D. Advantageously, reuse of the patterned light can improve energy efficiency of the additive manufacturing process, and in some cases improve energy intensity directed at a bed, or reduce manufacture time.

FIG. 3D is a cartoon 235 illustrating a simple geometrical transformation of a rejected energy beam for reuse. An input pattern 236 is directed into an image relay 237 capable of providing a mirror image pixel pattern 238. As will be appreciated, more complex pixel transformations are possible, including geometrical transformations, or pattern remapping of individual pixels and groups of pixels. Instead of being wasted in a beam dump, this remapped pattern can be directed to an article processing unit to improve manufacturing throughput or beam intensity.

FIG. 3E is a cartoon 235 illustrating multiple transformations of a rejected energy beam for reuse. An input pattern 236 is directed into a series of image relays 237B-E capable of providing a pixel pattern 238.

In another embodiment supporting light recycling and reuse, multiplex multiple beams of light from one or more light sources are provided. The multiple beams of light may be reshaped and blended to provide a first beam of light. A spatial polarization pattern may be applied on the first beam of light to provide a second beam of light. Polarization states of the second beam of light may be split to reflect a third beam of light, which may be reshaped into a fourth beam of light. The fourth beam of light may be introduced as one of the multiple beams of light to result in a fifth beam of light. In effect, this or similar systems can reduce energy costs associated with an additive manufacturing system. By collecting, beam combining, homogenizing and re-introducing unwanted light rejected by a spatial polarization valve or light valve operating in polarization modification mode, overall transmitted light power can potentially be unaffected by the pattern applied by a light valve. This advantageously results in an effective re-distribution of the light passing through the light valve into the desired pattern, increasing the light intensity proportional to the amount of area patterned.

Combining beams from multiple lasers into a single beam is one way to increase beam intensity. In one embodiment, multiple light beams, each having a distinct light wavelength, can be combined using either wavelength selective mirrors or diffractive elements. In certain embodiments, reflective optical elements that are not sensitive to wavelength dependent refractive effects can be used to guide a multiwavelength beam.

Patterned light can be directed using movable mirrors, prisms, diffractive optical elements, or solid state optical systems that do not require substantial physical movement. In one embodiment, a magnification ratio and an image distance associated with an intensity and a pixel size of an incident light on a location of a top surface of a powder bed can be determined for an additively manufactured, three-dimensional (3D) print job. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto the location of the top surface of the powder bed. Translational movements of compensating gantries and the build platform gantry are also able to ensure that distance of the incident light from the precursor mirror to the location of the top surface of the powder bed is substantially equivalent to the image distance. In effect, this enables a quick change in the optical beam delivery size and intensity across locations of a build area for different powdered materials while ensuring high availability of the system.

A plurality of build chambers can optionally be used, each having a build platform to hold a powder bed, can be used in conjunction with multiple optical-mechanical assemblies arranged to receive and direct the one or more incident energy beams into the build chambers. Multiple chambers allow for concurrent printing of one or more print jobs inside one or more build chambers. A removable chamber sidewall can simplify removal of printed objects from build chambers, allowing quick exchanges of powdered materials. The chamber can also be equipped with an adjustable process temperature controls.

One or more build chambers, as described above, can have a build chamber that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever-changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

Optionally, a portion of the layer of the powder bed may be selectively melted or fused to form one or more temporary walls out of the fused portion of the layer of the powder bed to contain another portion of the layer of the powder bed on the build platform. A fluid passageway can be formed in the one or more first walls to enable improved thermal management.

Improved powder handling can be another aspect of an improved additive manufacturing system. A build platform supporting a powder bed can be capable of tilting, inverting, and shaking to separate the powder bed substantially from the build platform in a hopper. The powdered material forming the powder bed may be collected in a hopper for reuse in later print jobs. The powder collecting process may be automated, and vacuuming or gas jet systems also used to aid powder dislodgement and removal

Some embodiments of the disclosed additive manufacturing system can be configured to easily handle parts longer than an available chamber. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

Optionally additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

Capability can be improved by having a 3D printer contained within an enclosure, the printer able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Optionally collecting powder samples can be collected in real-time in a powder bed fusion additive manufacturing system. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

According to the present disclosure, an optical system capable of recycling rejected, unwanted and/or unused light is provided. Recycling and re-using unwanted light may increase the intensity of laser emitted light that is provided to a build platform. Moreover, recycling and re-using unwanted light may reduce energy costs associated with the system. By collecting, beam combining, homogenizing and re-introducing unwanted light rejected by a spatial polarization valve or light valve operating in polarization modification mode, overall transmitted light power can potentially be unaffected by the pattern applied by the light valve. This advantageously results in an effective re-distribution of the light passing through the light valve into the desired pattern, thereby increasing the light intensity proportional to the amount of area patterned. This has particular use with regards to advanced additive manufacturing methods using powder bed fusion techniques (such as those described herein with respect to FIGS. 1A-3B) and in particular with laser additive manufacturing. This is because increased intensity can allow for shorter dwell times and faster print rates to increase material conversion rate while maintaining efficiency.

By way of a light valve or light modulator, a spatial pattern of light can be imprinted on a beam of light. When optical intensity is of a concern or figure of merit of the optical system, conservation of system power is a priority. Liquid crystal based devices are capable of patterning a polarized beam by selectively rotating “pixels” in the beam and then passing the beam through a polarizer to separate the rotated and non-rotated pixels. Instead of dumping the rejected polarization state, the photons may be combined and homogenized with the original input beam(s) to the light valve. The optical path may be divided into three segments, including: 1) optical transmission fraction between light source(s) and light valve (denoted as “f₁” herein), 2) optical transmission fraction between light valve and source, e.g., accounting for the return loop (denoted as “f₂” herein), and fraction of the light valve that is patterned for the desired transmission state (denoted as “fₚ” herein). The final light power may be expressed as follows in Equation 1:

$$P = {P}_{0} \frac{( {f}_{1} {f}_{p} )}{1 - {f}_{1} {f}_{2} ( 1 - {f}_{p} )} \qquad Equation 1$$

Thus, according to Equation 1, as the transmission fractions f₁ and f₂ are increased to a full value of 1, the final power equals the initial power regardless of fraction of the beam that is patterned. The final intensity is increased relative to the initial intensity proportional to the amount of area patterned. This increased intensity requires compensation in the dwell time, however this is known a priori.

One example implementation of this concept is in the field of additive manufacturing where lasers are used to melt a powdered layer of material. Without beam recycling, as the patterned area fill factor decreases, the material print rate also decreases, thereby lowering the overall mass production rate of the printer. Compensation in dwell time due to recycling of the light is such that for higher intensities, the dwell time is shortened in a non-linear fashion. Shorter dwell times tend to result in ever faster print rates and faster overall mass conversion rates. This ability to increase the rate of material printing for low fill factor print areas enables an additive manufacturing machine to maintain high levels of powder to engineered shape conversion rates, hence resulting in a higher performance product.

A further example implementation of this concept is in the use of a bar of light which sweeps over the build platform and is modulated on and off as swept to create a two-dimensional (2D) solid layer from the powder substrate. The use of recycled light in conjunction with this example is novel. The use of a bar, swept over the entire build platform, requires that it needs to be capable of always printing at 100% fill factor. Typically, however, only 10-33% of the build platform is ever used. This low fill factor means that, on average, the capital equipment in laser power is 3 to 10 times oversized for the system. If, however, the light can be recycled, and bar sweep speed modified to match required dwell times proportional to the fill factor, then the print speed can be increased such that it is closer to the optimum fill factor efficiency. In such cases the capital equipment may be fully utilized. The ability to print with a swept bar of light enables unidirectional printing, thereby simplifying the gantry system required to move the light around. Such ability also allows for easy integration of the powder sweeping mechanism.

A further example implementation of the print bar concept includes a powder distribution system that follows the bar, laying down the next layer of powder as the previous layer is printed. Advantageously, this may minimize system down time.

Another example implementation of light recycling is to share light with one or more other print chambers. This example effectively makes the available laser light seem like an on-demand resource, much like electricity being available at a wall outlet.

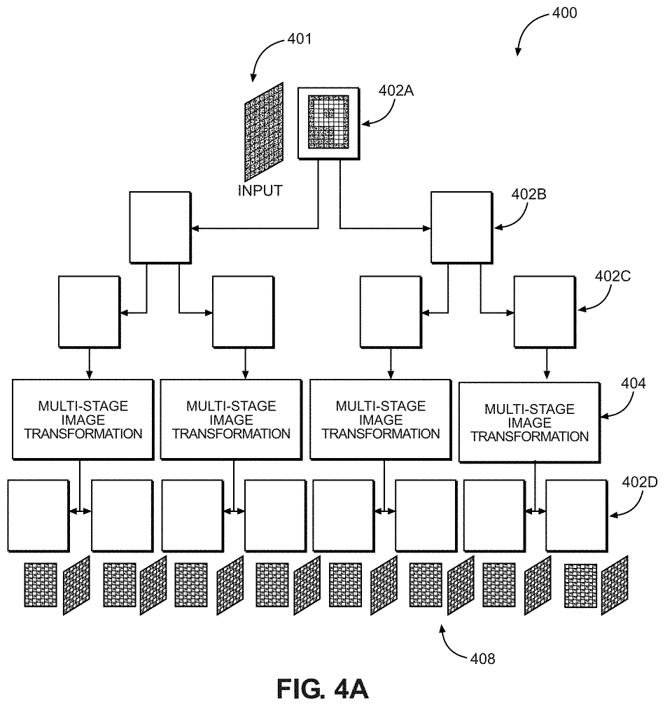

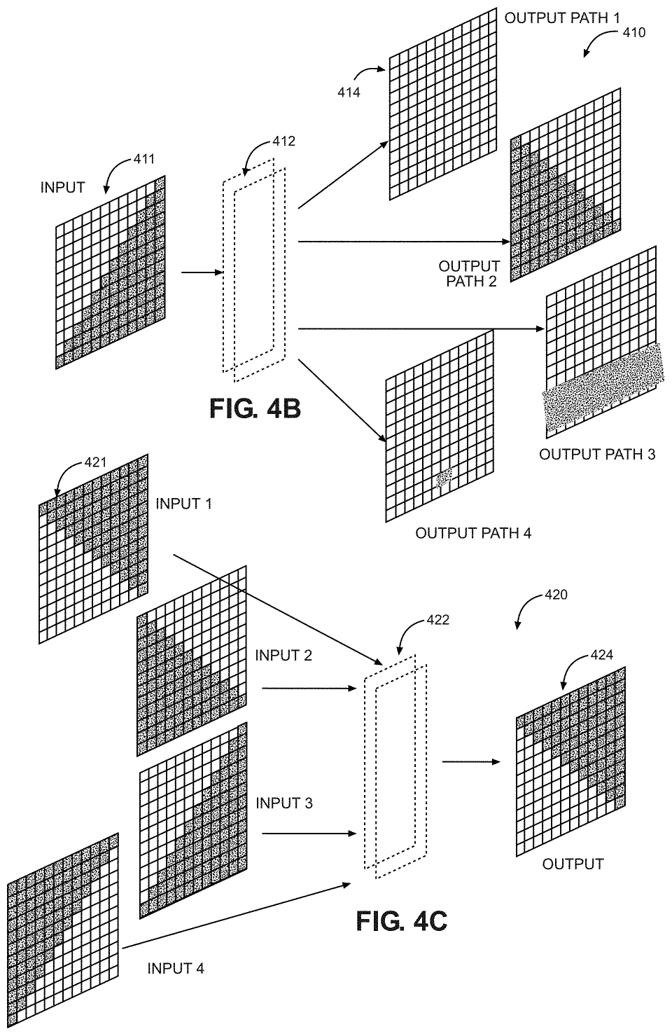

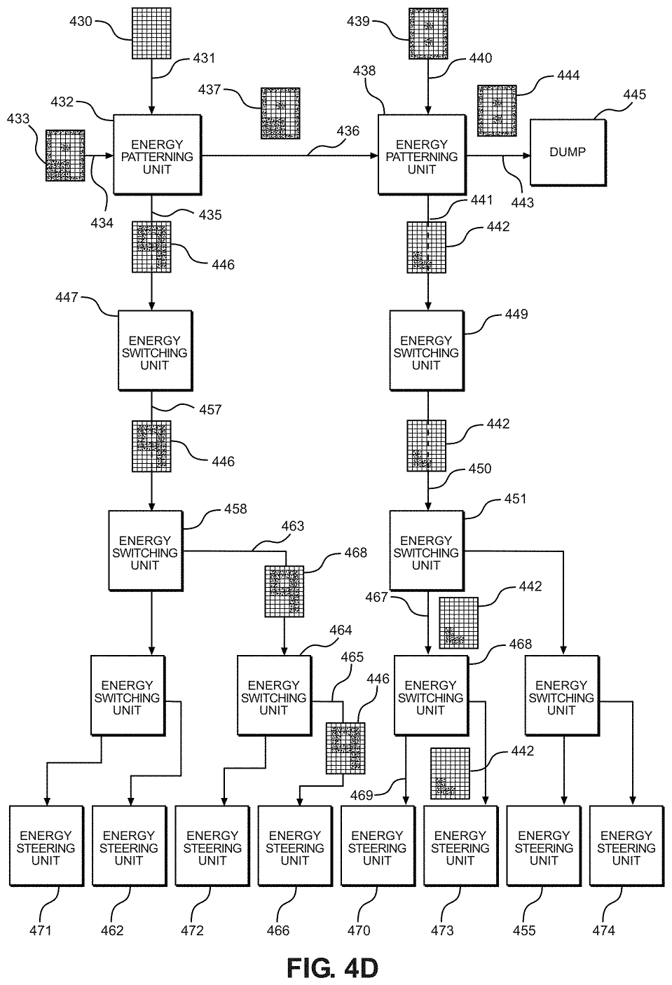

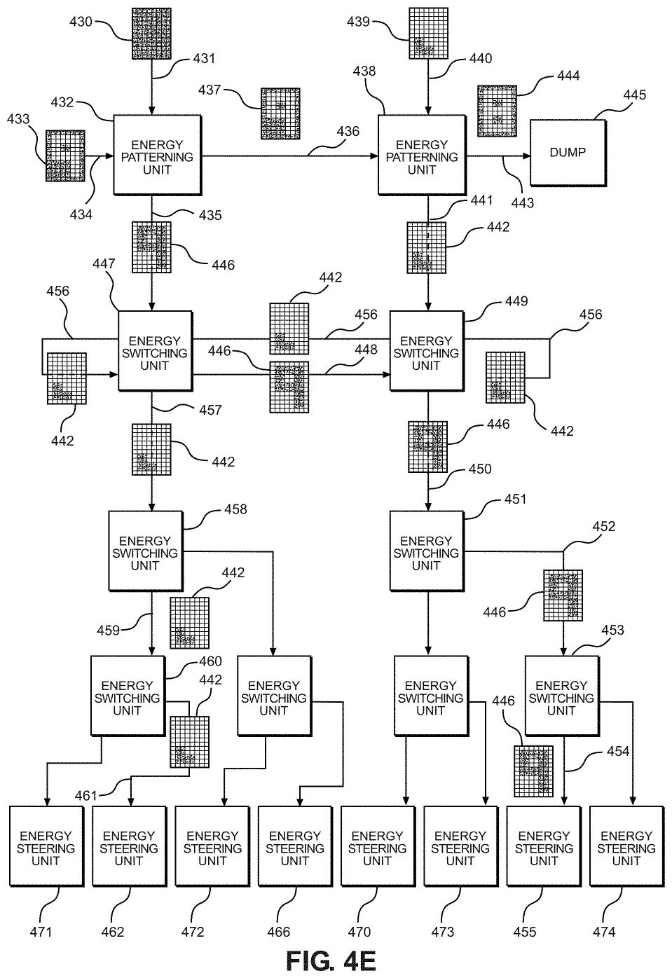

As previously noted with respect to FIG. 2 and the related description, recycling light does not have to be limited to reuse of homogenized, pattern-free light beams. Reuse of patterned images is also possible, with rejected light patterns capable of being inverted, mirrored, sub-patterned, or otherwise transformed for distribution to one or more article processing units. One embodiment for recycling light is shown in FIG. 4A, which illustrates an energy patterning binary tree system 400 able to generate 2ⁿ images from one input 401 and (2ⁿ−1) patterning levels 402a-d. At each stage, a “positive” light pattern and a “negative” or rejected light pattern counterpart can be created and directed toward additional patterning units or as patterned output 408. Each light pattern can be further modified through multistage transformations 404 which can modify patterns, reduce intensity in selected pattern regions, or otherwise change light characteristics.

FIG. 4B is a cartoon 410 illustrating pattern recycling from one input 411 to multiple outputs 414 by use of combined light patterning and steering mechanism 412. In this example, four output paths are provided, with a first possible output path having no patterned light, a second output path having a reduced light intensity pattern mirrored but otherwise identical to the input pattern 411, a third output path having a new pattern created by light pixel redirection, and a fourth output path having a significantly smaller and higher intensity pattern. As will be understood, these patterns are examples only, and a wide variety of output patterns that are smaller, larger, differently shaped, or have lower/higher light intensity patterns can be formed with suitable adjustments. In some embodiments, the output pattern can be modified by optical reflections, inversions, or the like of the whole input image, while in other embodiments, pixel block or individual pixel level adjustments are possible.

FIG. 4C is a cartoon 420 illustrating pattern recycling from multiple inputs 421 to an output 424 by use of combined light patterning and steering mechanism 422. In this example, four patterned inputs are combined into a higher intensity output 424, by rotating or flipping light input patterns 2, 3, and 4 to match and combine with input pattern 1. Similar to cartoon 4B, it should be understood that these patterns are examples only, and whole image, pixel block, or individual pixel level modifications to pattern and light intensity are allowed.

FIG. 4D is a schematic example of an implementation of the switchyard concept for additive manufacturing detailing two light valve patterning steps and beam re-direction where each image can only access half of the energy steering units. In this example, one image can only access beam steering units 471, 462, 472, and 466 while a second image can access 470, 473, 455, and 474. In operation, un-patterned infra-red beam 430 in a s-polarization state is incident on energy patterning unit 432 (similar to, for example, light patterning unit 316 of FIG. 3B) which is addressed by patterned ultra-violet image 433 (here a representation of the number “9” in an 8×12 pixel format) from a projector via beam 434. Wherever the UV light is incident on the energy patterning unit, the polarization state of beam 431 containing image information 433 is maintained. Upon incidence with the polarizer element inside of 430, energy patterning unit 432 then splits the beam, directing the image 446 in the p-polarization state along beam 435 to energy switching unit 447 (as described, for example, by X0 in FIG. 3C). The image 437 in s-polarization state is then sent along beam 436 to the second energy patterning unit 438 which is addressed by a UV beam 440 containing image information 439. Energy patterning unit 438 sends the image 442 in the p-pol state along beam 441 to energy switching unit 449. The image 444 in s-pol from energy patterning unit 438 is sent along beam 443 to beam dump 445 where it is rejected or otherwise utilized.

The first image, as represented as 446 is incident on energy switching unit 447 which receives beam 435 containing image information 446 in the p-pol state and in this example, passes it un-altered to beam 457, still containing image information 446 and maintaining p-polarization, which is then incident on energy switching unit 458. Energy switching unit 458 receives beam 457 containing image information 446 and, in this example, passes it to beam 463 converting to the s-polarization state, still containing image information 446, which is then incident on energy switching unit 464. Energy switching unit 464 receives beam 463 containing image information 446 and, in this example, passes it to beam 465 maintaining the s-polarization state, still containing image information 446, which is then incident on energy steering unit 466. Energy steering unit 466, which could be a mechanical (rotational) galvanometer or other solid state or rotational device, then directs beam 465 to the desired tile location on the print bed in its range of motion.

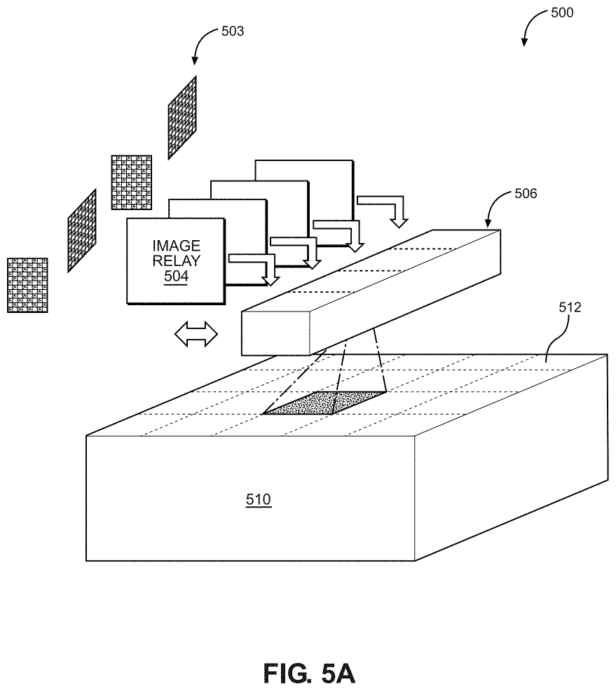

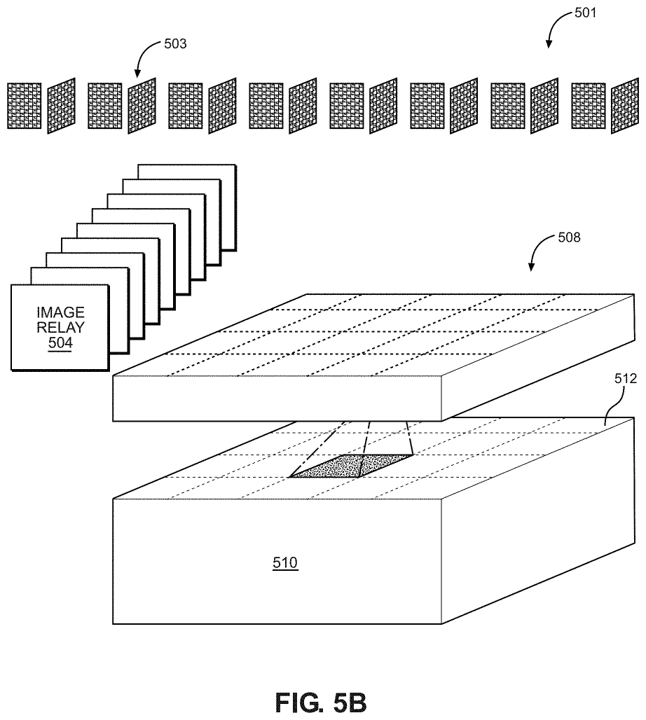

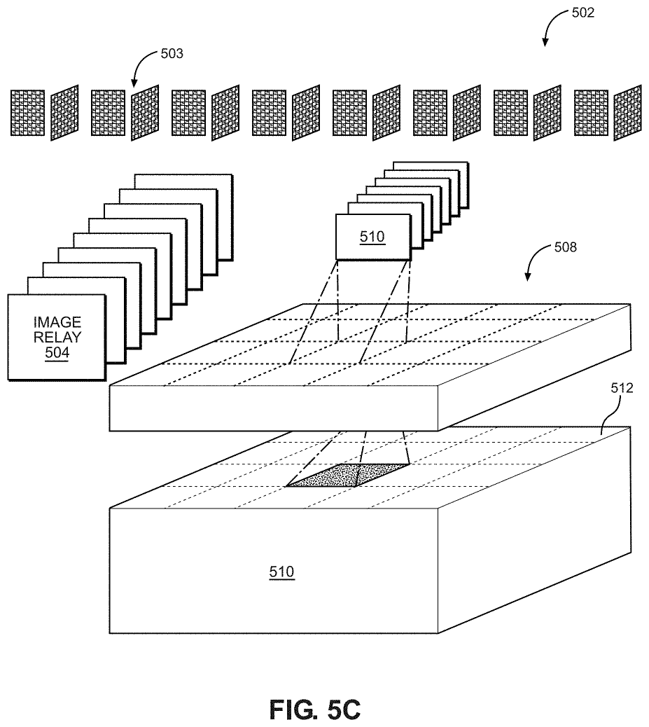

The second image, as represented as 442 is incident on energy switching unit 449 which receives beam 441 containing image information 442 in the p-pol state and in this example, passes it un-altered to beam 450, still containing image information 442 and maintaining p-polarization, which is then incident on energy switching unit 451. Energy switching unit 451 receives beam 450 containing image information 442 and, in this example, passes it to beam 467 maintaining p-polarization state, still containing image information 442, which is then incident on energy switching unit 468. Energy switching unit 468 receives beam 467 containing image information 442 and, in this example, passes it to beam 469 maintaining the p-polarization state, still containing image information 442, which is then incident on energy steering unit 470. Energy steering unit 470, which could be a mechanical (rotational) galvanometer or other solid state or rotational device, then directs beam 469 to the desired tile location on the print bed in its range of motion. In this example, the image relay such as discussed in the disclosure with respect to at least FIG. 3D and FIGS. 5A-C occurs between beams 435/441 and the energy steering units. Lenses, mirrors, and other pre-, post, or intermediate optics are not shown in this FIG. 4D, but could be utilized as needed.

FIG. 4E is a schematic example of an implementation of the switchyard concept detailing two light valve patterning steps and beam re-direction where switching is demonstrated to access the entirety of the energy steering units. In this example, one image can now access beam steering units 471, 462, 472, 466, 470, 473, 455, and 474. Un-patterned infra-red beam 430 in a s-polarization state is incident on energy patterning unit 432 (as described by 316 in FIG. 3B) which is addressed by patterned ultra-violet image 433 (here a representation of the number “9” in an 8×12 pixel format) from a projector via beam 434. Wherever the UV light is incident on the energy patterning unit, the polarization state of beam 431 containing image information 430 is maintained. Upon incidence with the polarizer element inside of 430, energy patterning unit 432 then splits the beam directing the image 446 in the p-polarization state along beam 435 to energy switching unit 447 (as described by X0 in FIG. 3C). The image 437 in s-polarization state is then sent along beam 436 to the second energy patterning unit 438 which is addressed by a UV beam 440 containing image information 439. Energy patterning unit 438 sends the image 442 in the p-pol state along beam 441 to energy switching unit 449. The image 444 in s-pol from energy patterning unit 438 is sent along beam 443 to beam dump 445 where it is rejected or otherwise utilized.

The first image 446 is incident on energy switching unit 447 which receives beam 435 containing image information 446 in the p-pol state and in this example, modifies the polarization state to s-polarization causing switching to beam 448, still containing image information 446, which is then incident on energy switching unit 449. Energy switching unit 449 receives beam 448 containing image information 446 and, in this example, passes it to beam 450 unaltered maintaining s-polarization state, still containing image information 446, which is then incident on energy switching unit 451 (this process is described in detail by the interaction of beam X1 with polarizer 382 into beam 317 in FIG. 3C). Energy switching unit 451 receives beam 450 containing image information 446 and, in this example, passes it to beam 452 maintaining the s-polarization state, still containing image information 446, which is then incident on energy switching unit 453. Energy switching unit 453 receives beam 452 containing image information 446 and, in this example, passes it to beam 454 maintaining the beam to the p-polarization state, still containing image information 446, which is then incident on energy steering unit 455. Energy steering unit 455, which could be a mechanical (rotational) galvanometer or other solid state or rotational device, then directs beam 454 to the desired tile location on the print bed in its range of motion.

The second image, as represented as 442 is incident on energy switching unit 449 which receives beam 441 containing image information 442 in the p-pol state and in this example, modifies the polarization state to s-polarization causing switching to beam 456, still containing image information 442, which is then incident on energy switching unit 447. Energy switching unit 447 receives beam 456 containing image information 442 and, in this example, passes it to beam 457 unaltered maintaining s-polarization state, still containing image information 442, which is then incident on energy switching unit 458 (this process is described in detail by the interaction of beam X1 with polarizer 382 into beam 317 in FIG. 3C). Energy switching unit 458 receives beam 457 containing image information 442 and, in this example, passes it to beam 459 modifying the beam to the p-polarization state, still containing image information 442, which is then incident on energy switching unit 460. Energy switching unit 460 receives beam 459 containing image information 442 and, in this example, passes it to beam 461 modifying the beam to the s-polarization state, still containing image information 446, which is then incident on energy steering unit 462. Energy steering unit 462, which could be a mechanical (rotational) galvanometer or other solid state or rotational device, then directs beam 461 to the desired tile location on the print bed in its range of motion. In this example, the image relay such as discussed in the disclosure with respect to at least FIG. 3D and FIGS. 5A-C occurs between beams 435/441 and the energy steering units. Lenses, mirrors, and other pre-, post, or intermediate optics are not shown in this FIG. 4E but could be utilized as needed.

FIG. 5A is a cartoon 500 illustrating area printing of multiple tiles using a print bar concept. The print bar 506 could contain galvanometer mirror sets, or a solid-state system that does not necessarily require move-able mirrors. Multiple input patterns 503 are redirected by multiple image relays 504 into a print bar 506 incorporating a solid-state array of image pipes and optics. The print bar 506 can be moved across powder bed 510 along a single axis as shown in the Figure, selectively irradiating one or more tiles 512. In other embodiments with larger powder beds, the print bar can be moved along both X and Y axes to cover the powder bed 510. In one embodiment, optics associated with the print bar can be fixed to support a single tile size, while in other embodiments, movable optics can be used to increase or reduce tile size, or to compensate for any Z-axis movement of the print bar. In another embodiment, patterned images can be created using recycled light patterns, including but not limited to an energy patterning binary tree system such as discussed with respect to FIG. 4A. In certain embodiments, multiple tiles can be simultaneously printed in a given time period. Alternatively, a subset of tiles can be printed at different times if available patterned energy, thermal issues, or other print bar configuration issues do not allow for complete utilization.

FIG. 5B is a cartoon 501 illustrating area printing of multiple tiles using an overhead fixed arrays system composed of multiple beam steering units. Beam steering units as demarcated unit cells in 508 can be composed of move-able mirrors (galvanometers) or an alternative solid state beam steering system. Multiple input patterns 503 are redirected by multiple image relays 504 into a matrix 508 incorporating an array of optics. The matrix 508 is sized to be coextensive with the powder, and does not need be moved across powder bed 510. This substantially reduces errors associated with moving a print bar, and can simplify assembly and operation of the system. In one embodiment, optics associated with the matrix can be fixed to support a single tile size, while in other embodiments, movable optics can be used to increase or reduce tile size, or to compensate for any Z-axis movement of the matrix 508. Like the embodiment discusses with respect to FIG. 5A, patterned images can be created using recycled light patterns, including but not limited to an energy patterning binary tree system such as discussed with respect to FIG. 4A, 4D, or 4E. In certain embodiments, multiple tiles can be simultaneously printed in a given time period. Alternatively, a subset of tiles can be printed at different times if available patterned energy, thermal issues, or other matrix configuration issues do not allow for complete utilization.

FIG. 5C is a cartoon 502 illustrating area printing of multiple tiles using an alternative hierarchical system. Multiple input patterns 503 are redirected by multiple image relays 504 into individual beam steering units 510, which in turn direct patterned images into a matrix 508 incorporating multiple optics and beam steering units. The matrix 508 is sized to be coextensive with the powder, and does not need be moved across powder bed 510. Like the embodiment discussed with respect to FIG. 5A, patterned images can be created using recycled light patterns, including but not limited to an energy patterning binary tree system such as discussed with respect to FIG. 4A. In certain embodiments, multiple tiles can be simultaneously printed in a given time period. Alternatively, a subset of tiles can be printed at different times if available patterned energy, thermal issues, or other matrix configuration issues do not allow for complete utilization.

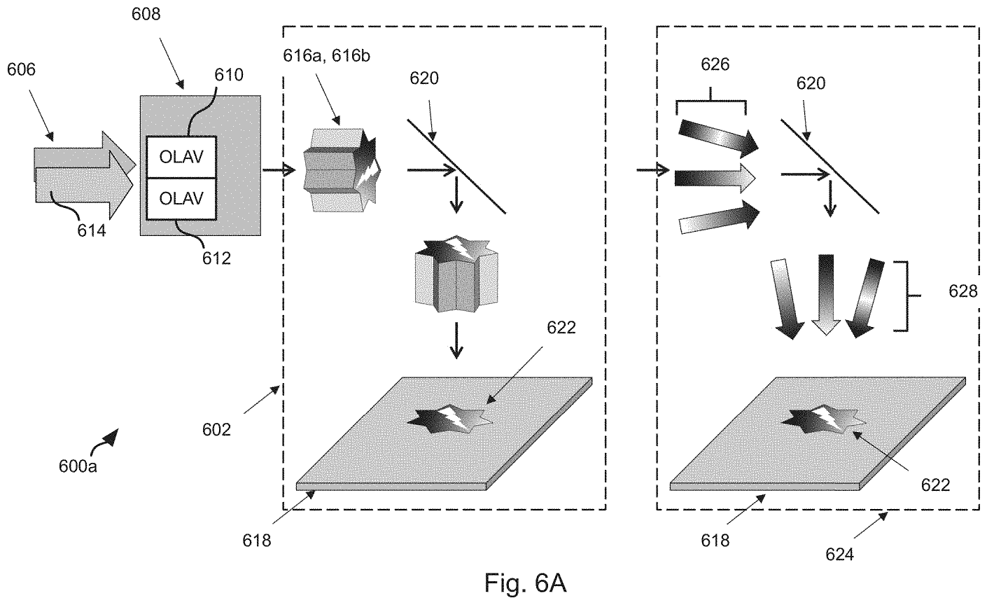

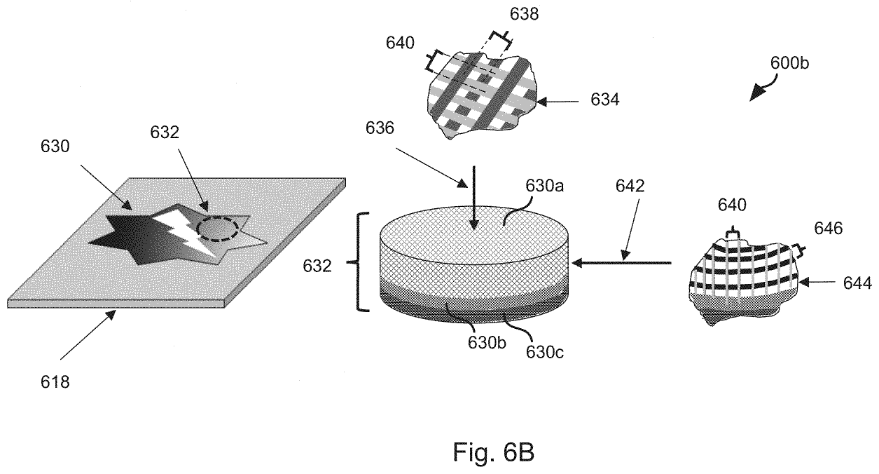

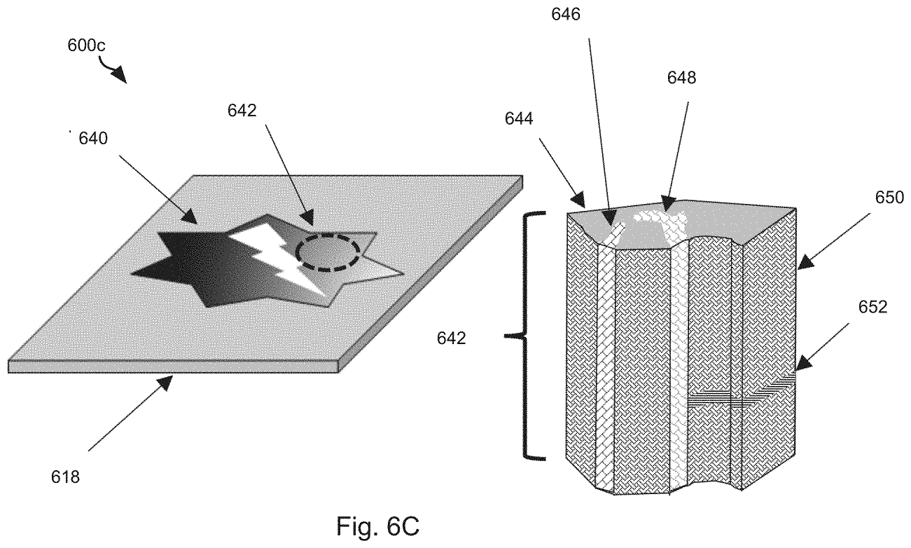

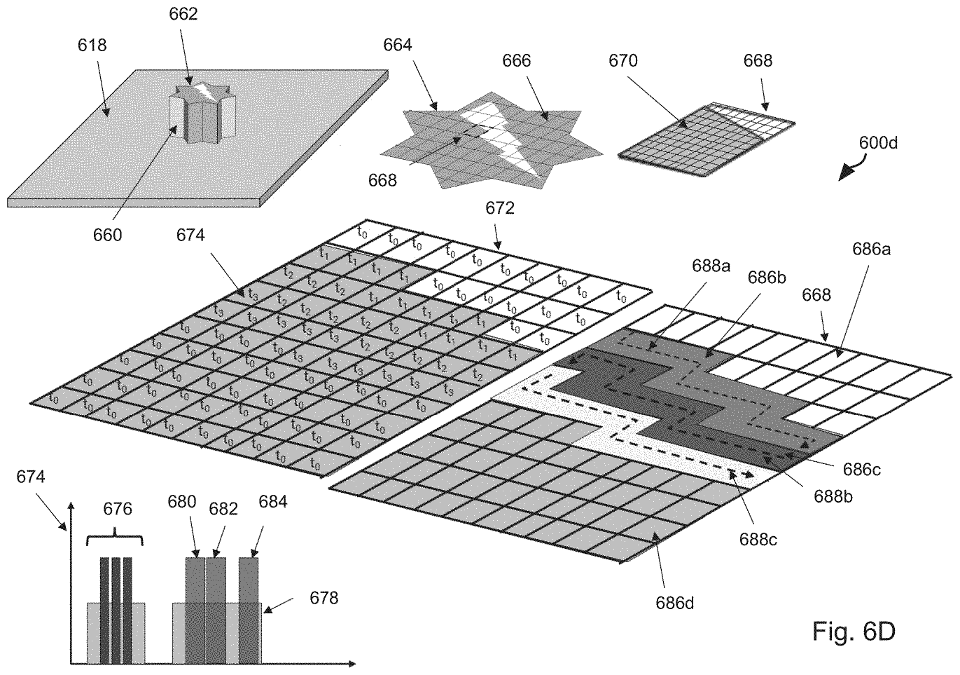

Referring to FIGS. 6A to 6D, in the method described above, a high fluence energy beam (e.g., beam 307) is image patterned with a two-dimensional pattern and then this patterned beam is transferred to a powder bed where the pattern is transferred into a molten metal pool on the powder bed with a direct spatial correlation to the two-dimensional pattern. As discussed above, the two-dimensional pattern may be a gray scale pattern. The methods described below with respect to FIG. 6A to 6C make use of two-dimensional gray scale patterns to achieve desired material characteristics beyond simply selecting which areas of the powder bed to melt. In particular, local control of spatial temperature gradients and heat flow may be controlled by selection of a two-dimensional gray scale pattern. The methods described below with respect to FIGS. 6A to 6C may also be implemented using binary intensity levels (e.g., 0% and 100 percent intensity) with adjustments to the duty cycle (duration of on and off periods) for each pixel of a two-dimensional pattern.

FIG. 6A illustrates a method 600a for gray scale area printing for performing additive manufacturing (AM). In a first example 602, amplitude-based methods may be used to perform area printing in AM. In a second example, phase-based methods 604 can be used to perform area printing in AM. Examples of amplitude- and phase-based are printing using two-dimensional gray scale patterns are described above with respect to FIG. 3A.

In both amplitude- and phase-based methods, an unpatterned High Fluence Light (HFL) (e.g., laser light) beam 606 is generated. The HFL beam 606 may be composed of light from a plurality of different sources blended and combined to form a single beam. The HFL beam 606 passes into a patterning device 608, which modifies some optical attribute of the HFL and impresses upon this attribute a desired two-dimensional gray scale image to print at the powder bed. In some implementations the patterning device 608 can include another optical element that separates the desired pattern from the undesired waste (beam) and sends the desired pattern to the bed while the undesired pattern goes into a switchyard system for recycling or into a beam dump.

The patterning device 608 may include one or more Optically Addressable Light Valves (OALVs). For example, the patterning device 608 may include one or more OALVs each implemented according to any of the approaches described above for implementing a light valve 380 as described above with respect to FIG. 3A. The OALVs can be used to print an image of the light valve (a ‘tile’) onto a layer of metal powder at the powder bed. The fluence of the HFL beam 606 on the OALV is limited by the laser induced damage threshold (LiDT) of the OALV. In other embodiments, the patterning device 608 is patterned by an electron beam as described above with respect to FIG. 3B.

In a first example, the patterning device 608 includes a first OALV 610 illuminated by the HFL beam 606 and second OALV 612 illuminated by a diode laser (DL) beam 614 from one or more DLs. The DL beam 614 and HFL beam 606 may have differing wavelengths, e.g. the DL beam may have a longer wavelength than the HFL beam 606. The HFL beam 606 may also have a pulse duration that is much shorter than the pulse length of the DL beam 614 since the high peak fluence of the HFL beam 606 can damage the OALV 610. The OALVs 610, 612 impart patterns onto the HFL beam 606 and DL beam, respectively, to obtain a patterned HFL beam 616a and a patterned DL beam 616b. The patterned beams 616a, 616b are directed to the print plane 618. The patterns imposed on the beams 606, 614 may be the same or different.

At the print plane 618, the patterned DL beam 616a raises the metal powder temperature to just below the melting point, and the shorter pulse of the patterned HFL beam 616b melts an area of powder (a ‘tile’) in the pattern imparted on the HFL beam 606 by the OALV 610 valve. The maximum size of the tile printed is dependent on the laser fluence the OALV can survive without laser damage. The overlap of light in the patterned beams 616a, 616b raises the fluence to above the threshold of the powder to melt.

The patterned beams 616a, 616b may be directed to the print plane 618 by means of one or more galvo/turning mirrors 620, which selectively direct the patterned beams 616a, 616b to different areas the printing plane 618 where the beams 616a, 616b melt powder and generate printed pattern 622 corresponding to the pattern(s) of the patterned beams 616a, 616b. The beams 616a, 616b may pass through one or more optical components before being incident on the one or more galvo/turning mirrors 620. Other beam steering modalities, such as liquid crystals, may also be used.

In a second example 624, phase-based grayscale generation is performed using a plurality of beams having a degree of coherence across the tile size in the printing plane 618. The coherence may be used to generate the two-dimensional pattern such that in some embodiments HFL beams have a degree of coherence at the printing plane 618. In contrast, the DL beams warm but do not melt the powder and may be unpatterned and not be coherent at the printing plane 618.

In phase-based grayscale, the high fluence beam 606 enters the patterning unit 608, which generates a patterned beam 616a which is then split into several beamlets 626 traveling on different paths. The phase patterning can be imposed on the high fluence beam 606 before splitting or may be imposed individually on each beamlet 626 by separate OALVs or different regions of a same OALV. In some embodiments, better coherence and improved modulation is obtained if patterning is imposed on the high fluence beam 616 before splitting. The beamlets 626 may be arranged using optics to eventually combine at the printing plane 618. The optics may include a path for each beamlet 616 and include compensation optics to adjust phase delay of each path to improve the phase dynamic range is achieved on the print bed. The beamlets 626 may then reflect off the galvo/folding mirror 620 before combining and overlapping 628 at the printing plane 618. The interference between the beamlets 626 creates a two-dimensional intensity pattern that melts a two-dimensional printed pattern 622 on the build plane.

The patterning unit 608 may be embodied as the phase interference device for imposing gray scale patterns described in U.S. application Ser. No. 17/670,149.

FIG. 6B illustrates an example 600b of controlling Young's modulus of the printed part using grayscale printing. In these examples, the printing plane 618 contains an exemplary layer 630 under print containing a volume 632 that is shown separated from the layer 630. This volume 632 is composed of the current print layer 630a and one or more prior print layers 630b, 630c. The volume 632 contains structured material that is printed using grayscale printing to construct its lattice structure as well as modify the grain features within the lattice structure.

Using the area printing approach described herein, each printed tile can be composed of millions of pixels. Herein “pixel” is used to describe an individual controlled area of the melt pool associated with a specific two-dimensional pattern of the incident HFL beam as opposed to an element of a two-dimensional image. The intensity of fluence observed by each pixel can be controlled across a grayscale dynamic range using any of the approaches described above. For example, adjacent pixels can have different grayscale values. In an example where different pixels have different greyscale values the melt pool sees a plurality of different fluence levels. This results in a temperature gradient from the pixel with more fluence (more delivered energy equates to higher temperature) to pixels with lower fluence (converse).

The global switch on time for the HFL pulse of the HFL beam and for the heating pulse of the DL beam allows the heat flow to stabilize in the direction from high fluence to low fluence. The grain structure that begins to form after the HFL pulse ends is in this same direction, thus grain structure follows heat flow from high fluence pixels to low fluence pixels. For example, the grain structure can be affected by both the temperature that a metallic structure is heated to, and the cooling time. In various examples, the grain size will increase with higher temperature. In other examples the grain structure will increase with increased cooling time. The grain structure can therefore be affected by the temperature the melt pool is heated to and/or the cooling period. The temperature profile imposed on each pixel of the melt pool also affects the microstructure of the grains themselves. For example, the type, or types, of crystals within each grain, the mixture of different crystal types within each grain. For example, in the case of steel, crystals grow in the form of martensite dendrites and austenite. Accordingly, the temperature profile may control the formation of martensite and austenite within each grain.

The relationship between grain size and microstructure of grains with respect to temperature profiles controlled at the level of each pixel may be obtained using the approaches described in the following references that are incorporated herein by reference in their entirety:
Ryan R, Dehoff, “Electron Beam Melting Technology Improvements,” Oak Ridge National Laboratory (January 2019)
Jorge Mireles et al., “Closed Loop Automatic Feedback Control in Electron Beam Melting,” Int. J. Adv. Manuf. Technol. 78:1193-1199 (2015)
Timothy Horn, “Material Development for Electron Beam Melting,” Center for Additive Manufacturing and Logistics, NC State University (2015)
T. Mahale et al., “Advances in Electron Beam Melting of Aluminum Alloys,” 2007 International Solid Freeform Fabrication Symposium
Tomas Kellner, “This Electron Gun Builds Jet Engines,” General Electric, (Aug. 18, 2014)
Sciaky Inc., “Sciaky to Deliver Industry-Leading Electron Beam Additive Manufacturing System to EWI, Sciaky Inc. (Jul. 20, 2016).

Material properties, such as stiffness, have a direct correlation to this grain growth and the resulting microstructure. Stiffness may be controlled by controlling thermal gradients in order to control the direction in which the grain is allowed to grow and/or the localized chemistry of each grain, such as the solute elements at the walls of each grain that may affect the Young's modulus. For example, stiffness can increase as grain size increases. The stiffness can therefore be higher than average in areas with higher-than-average grain size, and lower in areas with lower-than-average grain size. Therefore, the stiffness of an object created using an additive manufacturing process as described above can be controlled on a per pixel basis depending on the amount of fluence each pixel receives and therefore the temperature each pixel is heated to.

In another example, as well as the grain size, the lattice structure of the cooled material can be controlled based on the thermal gradient. For example, by controlling the thermal gradient of adjacent or nearby pixels and/or the cooling of the pixels it is possible to control the level of epitaxial growth and affect the overall structure of the material.

The grain structure between layers can be controlled by gray scale printing in concert with the temporal fluence control of the beams so cooling can occur from bottom up with columnar grain growth to follow the rate of cooling. The grain growth in this direction can be coupled with the feature dimensions. For example, an acoustical resonance may be created in the plane of the layer 630 allowing for acoustical resonance in in all three dimensions. The acoustical resonance in the layer-to-layer direction may be different from that that in the plane of the print layer 630 due to better control in the latter.

In an example, one or more cool pixels that are still above the sintering point will have a first stiffness, one or more moderately heated pixels that are above the melt-point will have a second stiffness and one or more pixels that have the highest temperature will have a third stiffness. For those regions within a tile that exhibit a thermal gradient (as per above fluence differences), the modulus will vary from one level to another. It should be noted that while the moduli are described as having “levels’ this does not necessarily describe a discrete change and the variation may be continuous.

Both the grain structure and the lattice structure can influence the thermal and acoustical properties of the cooled completed part. Both thermal and acoustical properties can be, at least in part, independently adjusted depending on the structure created and whether these structures are resonant with the acoustical field. As shown in view 634 of the volume 632 in a normal direction 636 relative to the print plane 618, the volume 632 can be composed of one or more types of lattices, for example, two or more types of lattices with a first periodicity 638 and a second periodicity 640 running orthogonal to each other may be observed. The width of each lattice feature in two dimensions of the printing plane 618 that are perpendicular to one another (e.g., dimensions ‘X’ ‘Y’) can be resonant at a particular acoustic frequency.

The acoustic properties can be formed according to the grayscale, for example, the gray scale along “X” and across “Y” may have a periodicity corresponding to a desired lattice spacing 638, 640. The spacing in the lattice openings can also be resonant at the same or different frequencies. In an embodiment, the acoustic resonance is a macroscopic result of the variation of the Young's modulus within a tile and between tiles as shown in the view 634. When viewed parallel to the plane along direction 642, print volume 632 can demonstrate a direction of the grain growth applied between layers as shown in view 644 shows the two or more lattice types with second periodicity (e.g., in the X or Y direction) and a third periodicity 646 (e.g., in the Z direction).

In another embodiment, by controlling Young's modulus and large-scale cross section areas of the desired paths, heat can be conducted in a specific manner to adjust thermal control. By increasing the density of the part from one layer to another layer or within any lateral volume to any lateral volume, thermal paths can be established within a part allowing the user to design and construct a thermal circuit for enhanced cooling in a finished part. For example, with reference to a normal (e.g. top down) view of the printed layer 630, a first layer 630b can be a first density and a second layer 630c can be of a second density. For example, the first layer 630b can be of a lower density and the second layer 630c can be of a higher density or vice-versa. While in the example shown in FIG. 1B the density increase is depicted to be a layer-to-layer density increase in other example implementations the density increase can be in plane or connected in any volume shape desired. The greyscale printing techniques described herein can enable thermal paths to be created within a tile, plane or across layers to generate these volumes. Density may be further controlled to adjust porosity in order to enable formation of heat pipes within a material along the X, Y, or Z directions or in non-perpendicular or curved paths relative to these directions.

FIG. 6C illustrates examples 600c of macroscopically aligned crystallography using grayscale printing. A build plane 618 holds a printed volume 640 including a volume 642 that is shown in detail in FIG. 6C. The volume 642 may represent one or more tile positions in a plane parallel to the build plane 618 or a portion of one tile position. Each tile may be composed of millions of image pixels. Each image pixel has an independent fluence value within a range of fluence values imposed by the OALV of any of the modalities listed above.

The top surface of the volume 640 that is currently being printed sits atop previously printed layers. Most of these layers are composed of the same oriented crystallographic structure 644 while other sections exhibit different crystallographic structure 646, 648, such as polycrystallographic structures. The structures 644, 646, 648 may span multiple layers of the volume 640 and may have the same shape in each layer or vary in shape from layer to layer to form structures 644, 646, 648 that have curved or other-shaped contours with boundaries that are non-perpendicular with respect to the build plane 618.

The crystallographic structures 644, 646, 648 may be formed layer by layer using grayscale printing across the tile or tiles forming the structures 644, 646, 648. Each grayscale level in the print image represents a different fluence that strikes the powder/melt pool for that pixel, and, in turn, represents a different temperature that that melt pool will attain. If there are different grayscale levels in the image across a tile, then there can be a temperature gradient from the higher fluence melt pools to the lower fluence melt pools (representing higher temperature to lower temperature gradients). As the HFL fluence wanes, these melt pools will begin to crystallize according to the temporal pulse function of the HFL coupled with the thermal gradient and the poly-crystalline formation of the material. Short or long grain structures form along these gradients depending on these factors (HFL beam characteristics, gradients, and crystalline orientation). A variety of material properties derive from both the crystalline orientation and the grain type (short or long and orientation) including yield strength, ductility, creep, fatigue, elongation, thermal and acoustical conduction, acoustical response and resonances, glassy response (ability to self-heal or crack arresting) and fracture strength.

Besides having structures 644, 646, 648 spanning multiple layers, one can construct one or more layers 652 within the volume 640 with different crystallographic structure than layers 650 above or below the one or more layers 652. This might be useful for volume stress relief, planned delamination, volumetric crack arresting, or ensuring an ever-sharp edge or similar controlled face upon micro-flaking. Additionally, these built-in features/defects can be used to incorporate desired thermal pathways or other controlled phononic features into the volume 640.

These features/defects can be phononic resonators that would allow local or global acoustic and thermionic resonances to be enhanced, controlled, or dissipated for better operational performance and may allow new mechanical abilities to manifest. A large body of knowledge using “phononic crystals” exists that these techniques could be used to create, manipulate, control, augment or dissipate phonons of varying different frequencies and time-space bandwidth products allowing for existing and new applications to be incorporated into AM parts. For example, if an appropriate part was constructed with a variety of phononic resonators scattered (by design) in a volume, then an outside stimulus applied at a particular point on the outside surface of the finished part could cause a series of acoustical resonances. Varying the stimuli's position and characteristics may induce other resonances resulting in other desired behaviors.

FIG. 6D illustrates examples 600d of temporal structuring of grayscale printing in the control of material characteristics. A build plane 618 holds a printed volume 660 being printed whose current print layer 662 is shown being printed. The current layer 662 is shown in detail as shape 664 formed of a matrix of tiles 666 each of which comprise an array of printed pixels. Each tile 668 of the tiles 666 is shown as an array of individual pixels 670. The fluence magnitude (gray scale value) and duration may be controlled for each pixel 670 of each tile 668. The fluence magnitude and duration may then be selected to control the properties at each pixel position within each layer corresponding to each pixel 670 when it is printed as the current layer 662. The number of pixels shown is exemplary and more or fewer pixels may be used depending on the resolution of the optical components used.

As shown in FIG. 6D, a tile 668 may include regions of pixels 670 having different material properties (shown by gray and white sections). Pixel matrix 672 shows exemplary timings 674 for each pixel 670 of a portion of the tile 668. For each pixel 670 there is shown a timing 674 with values tₙ, n=0, 1, 2, or 3 (or any other number) dependent on which region that pixel occupies. The time variable, tₙ, may define some or all of a pulse duration, interval between pulses, and a pattern of pulses for each pixel 670. Some or all of a pulse duration, an interval between pulses, and a pattern of pulses may be defined for one or both of the HFL beam and the DL beam.

For example, FIG. 6D shows a timing diagram 674 of pulse patterns for a pixel 670 with the horizontal axis being time and the vertical axis being intensity or amplitude of fluence. The taller (higher intensity) bars may correspond to fluence of the HFL beam and the lower (lower intensity) bars may correspond to the DL beam. In a first pattern 676, the DL beam has a single pulse with first pulse duration and the HFL beam has a plurality of second pulses with second durations that all occur during the first duration of the HFL beam. The second pulses may be separated by periods of zero fluence. The second pulses may be of equal or non-equal duration and the periods of zero fluence between second pulses may be of equal or non-equal duration. As shown the first pulse may begin before the first of the second pulses and may continue after the last of the second pulses of the pattern 676. The duration of the first pulse before the first of the second pulses and the duration of the first pulse after the last of the second pulses may be equal or non-equal.

In one example, the pattern 676 represents a baseline pattern corresponding to t₀. Patterns corresponding to t₁, t₂, t₃, or other timing values may be composed in various ways. In a first example, patterns corresponding to t₁, t₂, t₃ each a corresponding number of repetitions of the pattern 676. For example, pattern 678 includes pulses 680, 682, 684, which may each represent a second pulse of the HFL beam or an instance of the pattern 676. In either case, the pulses 680, 682, 684 may occur within the duration of a single first pulse of the DL beam. In one example, pulse 680 corresponds to t₁, pulse 682 to t₂, and pulse 684 to t₃.

In a second example, the duration of a zero HFL beam intensity preceding and/or following the pattern 676 is different for each pattern t₁, t₂, t₃. In a third example, the patterns corresponding to t₁, t₂, t₃ include second pulses with different intensities and/or durations than the second pulses of the baseline pattern 676. The variables of pulse duration, pulse intensity, duration of zero intensity between pulses, duration of zero intensity before and after the second pulses define a design space from which patterns may be defined to achieve desired material properties for a given pixel. In particular, duration of zero HFL intensity may permit cooling during or after execution of the pattern 676. Although the first pulse is shown as being constant in intensity it may have time-varying intensity across the pattern 676 that is accomplished using the gray scale patterned beam generation techniques described herein.

In the illustrated example, the timing sequences t0, t1, t2, t3 of the matrix 672 result in different regions 686a-686d of pixels within the tile 668, each region resulting in different material characteristics at corresponding pixel positions in the current print layer 662. For example, the first region 686a received fluence pattern t₀, region 686b received fluence pattern t₁, region 686c received fluence pattern t₃, and region 686d received fluence pattern t₀. In regions 686a, 686d, material characteristics may correspond to the grayscale intensity levels of the second pulses with relatively little alteration due to control of cooling rate. In contrast, regions 686b, 686c may different material properties due to the different patterns which provide for modified by the cooling rates dictated by second pulses and periods of zero HFL beam fluence in which cooling occurs.

The duration of first pulses, second pulses, and zero intensity periods between pulses may have a minimum duration determined by a switching period of the OALVs being used to pattern the HFL beam and DL beam. Likewise, the increment by which the durations of pulses may be changed may be a function of the switching period of the OALVs being used. For example, an OALV may have a switching period of from 10 to 50 ms.

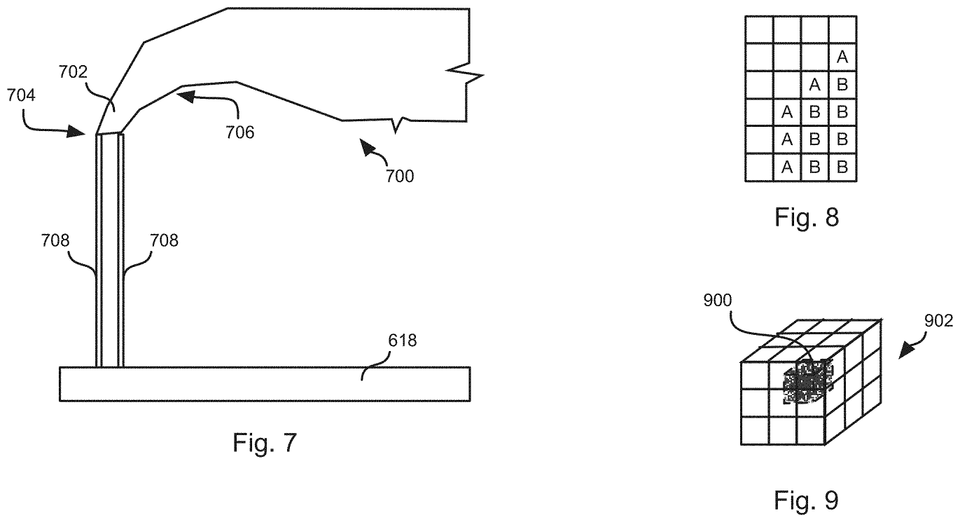

FIG. 7 illustrates an example application of the gray scale AM described herein. A part 700 may include a protrusion 702 having a distal end 704 that is closer to the print plane 618 than a point of attachment of a proximal end 706 of the protrusion 702 to the remainder of the part 700. The distal end 704 is printed before the proximal end 706 since a layer closer to the print plane 618 will be printed before a layer that is further from the print plane 618. Accordingly, supports 708 may be printed and span between the print plane 618 and the distal end 704 in order to hold the distal end 704 in place as subsequent layers are printed. The supports 708 are not part of the part 700 and therefore must be removed. In some embodiments, gray scale printing is used such that the supports 708 have different material properties than the part 700. For example, the supports 708 may be made more brittle, softer, and/or more porous than the material forming the part 700.

FIG. 8 illustrates another example application of the gray scale AM described herein. FIG. 8 illustrates a portion of the pixels of part in a plane parallel to the print plane 618 or perpendicular to the print plane 618. The blank pixels represent non-printed pixel such that, upon printing, areas of powder located within the projected tile will remain unmelted. The pixels marked “A” correspond to an edge of a printed part at the boundary between non-printed pixels and printed pixels. The pixels marked “B” correspond to the interior of the part that are not bounded by a non-printed pixel. The rate of heat flow out of the A pixels is different from the B pixels since the non-printed pixels are not melted. Using gray scale patterns, the intensity and/or duration of fluence applied to the powder at each pixel location of a tile may be adjusted to account for this. For example, A pixels may receive higher intensity fluence and/or higher duration fluence from the HFL beam than B pixels. In addition, non-printed pixels may still be illuminated by the DL beam in order to slow heat flow from the A pixels. The illustrated pixels may represent pixels in a plane parallel to the print plane 618 or perpendicular to the print plane 618.

Referring to FIG. 9, in a more general case, each pixel 900 may be understood as a center pixel in a 3×3×3 array 902 including the pixel 900 and all surrounding pixels. Testing, modeling, or a combination of the two may be performed for a large range of permutations of the 3×3×3 array of pixels 902. In particular, modeling and/or testing may be performed with respect to different permutations of printed and non-printed pixels, different values for various material properties (Young's modulus, porosity, hardness, strength, grain size, microcrystalline structure, etc.) for each pixel, and different gradients by which material properties vary across the 3×3×3 array of pixels 902. Modeling and/or testing may be performed to determine two-dimensional gray scale patterns and/or timing patterns that can be applied to each layer of the 3×3×3 array of pixels 902 in order to achieve any of the above-described permutations. Inasmuch as all but the center pixel 900 will be neighbored by other pixels, the modeling and testing may determine the gray scale intensity value and/or timing pattern for the pixel 900 given the properties of the pixel 900 and surrounding pixels defined by the permutation. Other array sizes may be modeled and/or tested, such as 5×5×5, 7×7×7, or N×M×P, where N, M, and P are integers greater than 3 that may be equal or non-equal.

Thereafter, for a given part and desired properties for each pixel of the part, the gray scale fluence value and/or timing pattern for each pixel may be selected based on the desired material properties (printed/non-printed, Young's modulus, porosity, hardness, strength, grain size, microcrystalline structure, etc.) and the desired material properties of the neighboring pixels. In particular, a matching array 902 may be identified and the gray scale fluence value and/or timing pattern may be selected for each pixel of the part based on the gray scale fluence and/or timing pattern of the center pixel 900 of the matching array 902.

In some situations, an exactly matching array may not exist. To accommodate this, various techniques may be used, such as rotating the matrix 902 to conform to the contours and/or gradient of the part. In some embodiments, a curve fitting, machine learning, or other technique may be used to relate the material properties of a matrix 902 to the gray scale fluence value and/or timing pattern of the center pixel 900. Where machine learning is used, a neural network, convolution neural network (CNN), deep neural network (DNN), or other type of machine learning model may be trained with training data entries each including a matrix 902 of one or more material properties (printed/non-printed, Young's modulus, porosity, hardness, strength, grain size, etc.) for each pixel of a three-dimensional array and, as a desired output, the gray scale fluence value and/or timing pattern of the center pixel 900 (or other pixel position) of the three-dimensional array. Each training data entry may be processed using the machine learning model to obtain an estimate. The estimate may be compared to the desired output of the training data entry. Parameters of the machine learning model may be adjusted according to a loss function that corresponds to differences between the estimate and the desired output. The machine learning model may then be utilized by inputting a three-dimensional array of desired properties to obtain gray scale fluence value and/or timing patterns for one or more pixels (e.g., the center pixel) of the three-dimensional array.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A method comprising:
depositing a layer of powder on a print plane;
writing a two-dimensional gray scale pattern to a light valve;
emitting an original light beam from a light source onto the light valve to obtain a patterned beam having a two-dimensional fluence pattern corresponding to the two-dimensional gray scale pattern; and
steering the patterned beam onto an area of the layer of powder to obtain a melted portion, the melted portion having two-dimensionally varying material properties in correspondence with the two-dimensional gray scale pattern.

2. The method of claim 1, wherein the two-dimensional gray scale pattern has at least three intensity levels.

3. The method of claim 1, wherein the two-dimensional gray scale pattern has at least three intensity levels selected from a range of at least 128 levels.

4. The method of claim 1, wherein the light valve modulates an amplitude of the original light beam to obtain the patterned beam.

5. The method of claim 1, wherein the light valve modulates a phase of the original light beam to obtain the patterned beam.

6. The method of claim 1, wherein the light valve modulates coherence of the original light beam to obtain the patterned beam.

7. The method of claim 1, wherein the light source is a first light source, the light valve is a first light valve, and the two-dimensional gray scale pattern is a first two-dimensional gray scale pattern, and the patterned beam is a first patterned beam, the method further comprising:
writing a second two-dimensional gray scale pattern to a second light valve;
emitting a low fluence beam onto the second light valve to obtain a low fluence patterned beam, the low fluence beam being insufficient to melt the layer of powder and having lower fluence than the first patterned beam; and
steering the low fluence patterned beam onto the area simultaneously with steering the first patterned beam onto the area.

8. The method of claim 7, wherein the first patterned beam comprises one or more first pulses and the low fluence beam comprises one or more second pulses, the one or more second pulses being longer than the one or more first pulses.

9. The method of claim 1, wherein the material properties include Young's modulus.

10. The method of claim 1, wherein the material properties include porosity.

11. The method of claim 1, wherein the material properties include grain size.

12. The method of claim 1, wherein the material properties include crystalline microstructure.

13. A system comprising:
a powder delivery system configured to deposit a layer of powder onto a build plane;
a light valve;
a patterning unit configured to write a series of two-dimensional gray scale patterns to the light valve;
a light source configured to emit an original light beam onto the light valve such that the light valve outputs a patterned beam corresponding to each two-dimensional gray scale pattern of the series of two-dimensional gray scale patterns;
a beam steerer configured to steer the patterned beam to a plurality of areas of the build plane to selectively melt portions of the layer of powder according to the series of two-dimensional gray scale patterns; and
a controller coupled to the light source, the patterning unit, and the beam steerer and configured to generate the series of two-dimensional gray scale patterns to achieve two-dimensionally varying material properties within the portions.

14. The system of claim 13, wherein the controller is further configured to generate the series of two-dimensional gray scale patterns in order to apply a pattern of pulses to each area of the plurality of areas.

15. The system of claim 14, wherein the series of two-dimensional gray scale patterns define an array of pixel positions, the controller programmed to independently control the pattern of pulses for each pixel position of the array of pixel positions.

16. The system of claim 13, wherein the light source is a first light source, the light valve is a first light valve, the original light beam is a first original light beam, the patterned beam is a first patterned beam, and the series of two-dimensional gray scale patterns is a series of first two-dimensional gray scale patterns;
wherein the system further comprises:
a second light valve; and
a second light source configured to emit a second original light beam onto the second light valve, the second light source having less fluence than the first light source that is insufficient to melt the layer of powder;
wherein the patterning unit is configured to write a series of second two dimensional gray scale patterns to the second light valve such that the second light valve outputs a second patterned beam corresponding to each second two-dimensional gray scale pattern of a series of second two-dimensional gray scale patterns; and
wherein the series of first two-dimensional gray scale patterns and the series of first two-dimensional gray scale patterns define an array of pixel positions, the controller programmed to independently control a first pattern of first pulses in the first patterned beam for each pixel position of the array of pixel positions and independently control a second pattern of second pulses in the second patterned beam for each pixel position of the array of pixel positions.

17. The system of claim 16, wherein the first light source is a high fluence laser and the second light source is a diode laser.

18. The system of claim 13, wherein the controller is configured to at least one pattern of the series of two-dimensional gray scale pattern including at least three intensity levels selected from a range of at least 128 levels.

19. The system of claim 13, wherein the light valve is configured to modulate one of:
an amplitude of the original light beam to obtain the patterned beam;
a phase of the original light beam to obtain the patterned beam; or
coherence of the original light beam to obtain the patterned beam.

20. The system of claim 13, wherein the material properties include one or more of Young's modulus, porosity, grain size, and crystalline microstructure.
